(19) United States
(12) Patent Application Publication
(10) Pub. No.: US 2025/0261092 A1
(43) Pub. Date: Aug. 14, 2025

(54) SYSTEMS AND METHODS FOR SYSTEM INFORMATION ACCUMULATION IN INTERNET OF THINGS NON-TERRESTRIAL NETWORKS

(71) Applicant: TELEFONAKTIEBOLAGET LM ERICSSON (PUBL), STOCKHOLM (SE)

(72) Inventors: Talha Khan, Santa Clara, CA (US); Johan Rune, Stockholm (SE); Olof Liberg, Stockholm (SE); Jonas Sedin, Stockholm (SE); Gerardo Agni Medina Acosta, Stockholm (SE)

(21) Appl. No.: 18/859,504

(22) PCT Filed: Apr. 24, 2023
(86) PCT No.: PCT/IB2023/054196

§ 371 Date: Oct. 23, 2024

Related U.S. Application Data
(60) Provisional application No. 63/334,101, filed on Apr. 23, 2022.
(60) Provisional application No. 63/334,236, filed on Apr. 25, 2022.

(51) Int. Cl. H04W 48/16; H04W 56/00; H04W 84/06

(52) U.S. Cl. CPC H04W 48/16; H04W 56/001; H04W 84/06

(57) ABSTRACT

A method is provided by a user equipment (UE) for determining whether System Information (SI) message accumulation is prohibited or allowed. The method includes obtaining information about SI message accumulation. Based on the information, the UE determines whether SI message accumulation is prohibited or allowed in a Non-Terrestrial Network (NTN) cell.

### TECHNICAL FIELD

The present disclosure relates, in general, to wireless communications and, more particularly, systems and methods for System Information (SI) accumulation in Internet of Things (IoT) Non-Terrestrial Networks (NTNs).

### BACKGROUND

In 3^{rd} Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since 3GPP Release 13, NB-IoT and LTE-Machine Type Communication (LTE-M) are part of the LTE specifications and provide connectivity to massive machine type communications (mMTC) services.

In 3GPP Release 15, the first release of the 5G system (5GS) was specified. This is a new generation's radio access technology intended to serve use cases such as enhanced mobile broadband (eMBB), ultra-reliable and low latency communication (URLLC) and mMTC. 5G includes the New Radio (NR) access stratum interface and the 5G Core Network (5GC). The NR physical and higher layers are reusing parts of the LTE specification, and to that add needed components when motivated by the new use cases. One such component is the introduction of a sophisticated framework for beam forming and beam management to extend the support of the 3GPP technologies to a frequency range going beyond 6 GHz.

There is an ongoing resurgence of satellite communications. Several plans for satellite networks have been announced in the past few years. The target services vary, from backhaul and fixed wireless, to transportation, to outdoor mobile, to IoT. Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest, which has been reflected in the 3GPP standardization work. In 3GPP Release 15, 3GPP started the work to prepare NR for operation in a Non-Terrestrial Network (NTN). The work was performed within the study item “NR to support Non-Terrestrial Networks” and resulted in 3GPP TR 38.811.

In 3GPP Release 16, the work to prepare NR for operation in an NTN network continued with the study item “Solutions for NR to support Non-Terrestrial Network”, which has been captured in 3GPP TR 38.821. In parallel, the interest to adapt NB-IoT and LTE-M for operation in NTN is growing. As a consequence, 3GPP Release 17 contained both a work item on NR NTN and a study item on NB-IoT and LTE-M support for NTN.

A satellite radio access network usually includes the following components:
a satellite that refers to a space-borne platform;
an earth-based gateway that connects the satellite to a base station or a core network, depending on the choice of architecture;
a feeder link that refers to the link between a gateway and a satellite; and
an access link, or service link, that refers to the link between a satellite and a User Equipment (UE).

Depending on the orbit altitude, a satellite may be categorized as low earth orbit (LEO), medium earth orbit (MEO), or geostationary earth orbit (GEO) satellite:
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

Two basic architectures can be distinguished for satellite communication networks, depending on the functionality of the satellites in the system:
Transparent payload (also referred to as bent pipe architecture): The satellite forwards the received signal between the terminal and the network equipment on the ground with only amplification and a shift from uplink (UL) frequency to downlink (DL) frequency. When applied to general 3GPP architecture and terminology, the transparent payload architecture means that the gNB is located on the ground and the satellite forwards signals/data between the gNB and the UE
Regenerative payload: The satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP Release 17, only the transparent payload architecture is considered.

FIG. 1 shows an example architecture of a satellite network with bent pipe transponders (i.e. the transparent payload architecture. The gNB may be integrated in the gateway or connected to the gateway via a terrestrial connection (wire, optic fiber, wireless link).

A communication satellite typically generates several beams over a given area. The footprint of a beam is usually in an elliptic shape, which has traditionally been considered as a cell, but cells consisting of the coverage footprint of multiple beams are not excluded in the 3GPP work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

Propagation delay is an important aspect of satellite communications that is different from the delay expected in a terrestrial mobile system. For a bent pipe satellite network, the round-trip delay may, depending on the orbit height, range from tens of ms in the case of LEO satellites to several hundreds of milliseconds (ms) for GEO satellites. As a comparison, the round-trip delays in terrestrial cellular networks are typically below 1 ms.

The distance between the UE and a satellite can vary significantly, depending on the position of the satellite and thus the elevation angle & seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles.

| | | | Distance | | One-way | | |
|---|---|---|---|---|---|---|---|
| Orbital | | Elevation | UE <-> | | propagation | | Propagation |
| height | | angle | satellite | | delay | | delay difference |
| 600 | km | 90° | 600 | km | 2.0 | ms | — |

| | | | | | | |
|---|---|---|---|---|---|---|
| 30° | 1075 | km | 3.6 | ms | 1.6 | ms |
| 10° | 1932 | km | 6.4 | ms | 4.4 | ms |

| | | | | | | | |
|---|---|---|---|---|---|---|---|
| 1200 | km | 90° | 1200 | km | 4.0 | ms | — |

| | | | | | | |
|---|---|---|---|---|---|---|
| 30° | 1999 | km | 6.7 | ms | 2.7 | ms |
| 10° | 3131 | km | 10.4 | ms | 6.4 | ms |

| | | | | | | | |
|---|---|---|---|---|---|---|---|
| 35786 | km | 90° | 35786 | km | 119.4 | ms | — |

| | | | | | | |
|---|---|---|---|---|---|---|
| 30° | 38609 | km | 128.8 | ms | 9.4 | ms |
| 10° | 40581 | km | 135.4 | ms | 16.0 | ms |

The propagation delay may also be highly variable due to the high velocity of the LEO and MEO satellites and change in the order of 10-100 us every second, depending on the orbit altitude and satellite velocity.

For NTNs using 3GPP technology, in particular 5G/NR, the long propagation delay means that the timing advance (TA) the UE uses for its UL transmissions is essential and has to be much greater than in terrestrial networks in order for the UL and DL to be time aligned at the gNB, as is the case in NR and LTE. One of the purposes of the random access (RA) procedure is to provide the UE with a valid TA (which the network later can adjust based on the reception timing of UL transmission from the UE). However, even the random access preamble (i.e. the initial message from the UE in the random access procedure) has to be transmitted with a TA to allow a reasonable size of the RA preamble reception window in the gNB (and to ensure that the cyclic shift of the preamble's Zadoff-Chu sequence cannot be so large that it makes the Zadoff-Chu sequence, and thus the preamble, appear as another Zadoff Chu sequence, and thus preamble, based on the same Zadoff-Chu root sequence), but this TA does not have to be as accurate as the TA the UE subsequently uses for other UL transmissions.

The TA the UE uses for the RA preamble transmission in NTN is called “pre-compensation TA”. Various proposals are considered for how to determine the pre-compensation TA, all of which involve information originating both at the gNB and at the UE. In brief, the discussed alternative proposals include:
The network broadcasts a “common TA” that is valid at a certain reference point, e.g. a center point in the cell. The UE would then calculate how its own pre-compensation TA deviates from the common TA, based on the difference between the UE's own location and the reference point together with the position of the satellite. The UE may acquire its own position using Global Navigation Satellite System (GNSS) measurements, and the UE may obtain the satellite position using satellite orbital data (including satellite position at a certain time) that is broadcast by the network.
The UE autonomously calculates the propagation delay between the UE and the satellite, based on the UE's and the satellite's respective positions, and the network/gNB broadcasts the propagation delay on the feeder link, i.e. the propagation delay between the gNB and the satellite. The UE may acquire its own position using GNSS measurements, and the UE may obtain the satellite position using satellite orbital data (including satellite position at a certain time) that is broadcast by the network. The pre-compensation TA is then twice the sum of the propagation delay on the feeder link and the propagation delay between the satellite and the UE.
The gNB broadcasts a timestamp (in System Information Block-9 (SIB9)), which the UE compares with a reference timestamp acquired from GNSS. Based on the difference between these two timestamps, the UE can calculate the propagation delay between the gNB and the UE. The pre-compensation TA is twice as long as this propagation delay.

In conjunction with the RA procedure, the gNB provides the UE with an accurate (i.e., fine-adjusted) TA in the Random Access Response message (in a 4-step RA procedure) or the MsgB (in a 2-step RA procedure), based on the time of reception of the random access preamble. The gNB can subsequently adjust the UE's TA using a Timing Advance Command Medium Access Control-Control Element (MAC CE) (or an Absolute Timing Advance Command MAC CE), based on the timing of receptions of UL transmissions from the UE. A goal with such network control of the UE's TA is typically to keep the time error of the UE's UL transmissions at the gNB's receiver within the cyclic prefix (which is required for correct decoding of the UL transmissions). The time advance control framework also includes a time alignment timer that the gNB configures the UE with. The time alignment timer is restarted every time the gNB adjusts the UE's TA and if the time alignment timer expires, the UE is not allowed to transmit in the UL without a prior RA procedure (which serves the purpose to provide the UE with a valid TA). For NTN, 3GPP has also agreed that, in addition to the gNB's control of the UE's TA, the UE is allowed to autonomously update its TA based on estimation of changes in the UE-gNB round-tip time (RTT) using the UE's location (e.g., obtained from GNSS measurement) and knowledge of the serving satellite's ephemeris data and feeder link delay information from the gNB.

A second relevant aspect is that not only is the propagation delay between the UE and a satellite, or between the UE and a gNB, very long in NTN, but due to the large distances, the difference in propagation delay to two different satellites, or two different gNBs, may be significant on the timescales relevant for cellular communication, including signaling procedures, even when the satellites/gNBs serve neighboring cells. This has an impact on all procedures involving reception or transmission in two cells served by different satellites and/or different gNBs.

A third important aspect related to the long propagation delay/RTT in NTNs is the introduction of an additional parameter to compensate for the long propagation delay/RTT. In terrestrial cellular networks, the UE-gNB RTT may range from more or less zero to several tens of microseconds in a cell. A major difference in NTNs, apart from the sheer size of the propagation delay/RTT, is that even at the location in the cell where the propagation delay/RTT is the smallest, it will be large and nowhere close to zero. In fact, the variation of the propagation delay/RTT within a NTN cell is small compared to the propagation delay/RTT. This speaks in favor of introducing an offset, which essentially takes care of the RTT between the cell's footprint on the ground and the satellite, while other mechanisms, including signaling and control loops, take care of the RTT dependent aspects within the smaller range of RTT variation within the cell on top of the offset. To this end, 3GPP has agreed to introduce such a parameter, which is denoted Koffset (or sometimes K_offset).

The Koffset parameter may potentially be used in various timing related mechanisms, but the application mainly in focus is to use it in the scheduling of UL transmissions on the Physical Uplink Shared Channel (PUSCH). Koffset is used to indicate an additional delay between the UL grant and the PUSCH transmission resources allocated by UL grant to be added to the slot offset parameter K2 in the DCI containing the UL grant. The offset between the UL grant and the slot in which the PUSCH transmission resources are allocated is thus Koffset+K2. When used this way in UL scheduling, Koffset can be said to serve the purpose to ensure that the UE is never scheduled to transmit at a point in time that, due to the large TA the UE has to apply, would occur before the point in time when the UE receives the UL grant. In 3GPP, it is also discussed to let the network's configuration of Koffset take into account the TA the UE may have signaled that it has used.

A fourth important aspect closely related to the timing is a Doppler frequency offset induced by the motion of the satellite. The access link may be exposed to Doppler shift in the order of 10-100 kHz in sub-6 GHz frequency band and proportionally higher in higher frequency bands. Also, the Doppler shift is varying, with a rate of up to several hundred Hz per second in the S-band and several kHz per second in the Ka-band.

In 3GPP TR 38.821, it has been captured that ephemeris data should be provided to the UE, for example, to assist with pointing a directional antenna (or an antenna beam) towards the satellite and to calculate a correct TA and Doppler shift. Procedures on how to provide and update ephemeris data have not yet been studied in detail, though, but broadcasting of ephemeris data in the system information is one option.

A satellite orbit can be fully described using 6 parameters. Exactly which set of parameters is chosen can be decided by the user and/or network operator; many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch t determines a reference time (e.g., the time when the satellites moves through periapsis). FIG. 2 illustrates this set of parameters, which is also referred to as orbital elements.

As an example of a different parametrization, the Two-Line Elements (TLEs) use mean motion n and mean anomaly M instead of a and t. A completely different set of parameters is the position and velocity vector (x, y, z, vx, vy, vz) of a satellite. These are sometimes called orbital state vectors. They can be derived from the orbital elements and vice versa, since the information they contain is equivalent. All these formulations (and many others) are possible choices for the format of ephemeris data to be used in NTN. To enable further progress, the format of the data should be agreed upon.

It is important that a UE can determine the position of a satellite with accuracy of at least a few meters. However, several studies have shown that this might be hard to achieve when using the de-facto standard of TLEs. On the other hand, LEO satellites often have GNSS receivers and can determine their position with some meter level accuracy.

Another aspect discussed during the study item and captured in 3GPP TR 38.821 is the validity time of ephemeris data. Predictions of satellite positions in general degrade with increasing age of the ephemeris data used, due to atmospheric drag, maneuvering of the satellite, imperfections in the orbital models used, etc. Therefore, the publicly available TLE data are updated quite frequently, for example. The update frequency depends on the satellite and its orbit and ranges from weekly to multiple times a day for satellites on very low orbits which are exposed to strong atmospheric drag and need to perform correctional maneuvers often.

So, while it seems possible to provide the satellite position with the required accuracy, care needs to be taken to meet these requirements such as, for example, when choosing the ephemeris data format or the orbital model to be used for the orbital propagation.

As the outcome of the study items in 3GPP lay the foundation for the specification work of NTNs in 3GPP, it is relevant as background information for the present disclosure.

The TR of the second study item, 3GPP TR 38.821, describes scenarios for the NTN work as follows:

NTN typically features the following elements:
One or several sat-gateways that connect the NTN to a public data network
   a GEO satellite is fed by one or several sat-gateways which are deployed across the satellite targeted coverage (e.g. regional or even continental coverage). We assume that UE in a cell are served by only one sat-gateway
   A Non-GEO satellite served successively by one sat-gateway at a time. The system ensures service and feeder link continuity between the successive serving sat-gateways with sufficient time duration to proceed with mobility anchoring and hand-over

Four scenarios are considered as depicted in Table 4.2-1 and are detailed in Table 4.2-2.

TABLE 4.2-1
Reference scenarios

| | Transparent | Regenerative |
|---|---|---|
| | satellite | satellite |
| GEO based non-terrestrial access network | Scenario A | Scenario B |
| LEO based non-terrestrial access network | Scenario C | Scenario D |

TABLE 4.2-2
Reference scenario parameters

| | GEO based non-terrestrial | | LEO based non- | |
|---|---|---|---|---|
| | access network (Scenario A | | terrestrial access | |
| Scenarios | and B) | | network (Scenario C & D) | |
| Orbit type | Notional station keeping position | | Circular orbiting around | |
| | fixed in terms of | | the earth | |
| | elevation/azimuth with respect to | | | |
| | a given earth point | | | |
| Altitude | 35,786 | km | 600 km | |
| | | | 1,200 km | |
| Spectrum (service link) | <6 GHz (e.g. 2 GHz) | | | |
| | >6 GHz (e.g. DL 20 GHz, UL 30 GHz) | | | |
| Max channel bandwidth | 30 MHz for band <6 GHz | | | |
| (service link) | 400 MHz for band >6 GHz | | | |
| Payload | Scenario A: Transparent | | Scenario C: | |
| | (including radio frequency | | Transparent (including | |
| | function only) | | radio frequency | |
| | Scenario B: regenerative | | function only) | |
| | (including all or part of RAN | | Scenario D: | |
| | functions) | | Regenerative (including | |
| | | | all or part of RAN | |
| | | | functions) | |
| Inter-Satellite link | No | | Scenario C: No | |
| | | | Scenario D: Yes | |
| Earth-fixed beams | Yes | | Scenario C: No (the | |
| | | | beams move with the | |
| | | | satellite) | |
| | | | Scenario D, option 1: | |
| | | | Yes (steering beams), | |
| | | | see note 1 | |
| | | | Scenario D, option 2: | |
| | | | No (the beams move | |
| | | | with the satellite) | |
| Max beam foot print | 500 | km | 200 km | |
| diameter at nadir | | | | |
| Min Elevation angle for | 10° | | 10° | |
| both sat-gateway and | | | | |
| user equipment | | | | |
| Max distance between | 40,586 | km | 1,932 km (600 km | |
| satellite and user | | | altitude) | |
| equipment at min | | | 3,131 km (1,200 km | |
| elevation angle | | | altitude) | |
| Max Round Trip Delay | Scenario A: 562 ms (service | | Scenario C: 25.76 ms | |
| (propagation delay | and feeder links) | | (transparent payload: | |
| only) | Scenario B: 281 ms | | service and feeder | |
| | | | links) | |
| | | | Scenario D: 12.88 ms | |
| | | | (regenerative payload: | |
| | | | service link only) | |
| Max delay variation | 16 | ms | 4.44 | ms (600 km) |
| within a beam (earth | | | 6.44 | ms (1200 km) |
| fixed user equipment) | | | | |
| Max differential delay | 1.6 | ms | 0.65 | ms (*) |
| within a beam | | | | |
| Max Doppler shift (earth | 0.93 | ppm | 24 | ppm (*) |
| fixed user equipment) | | | | |
| Max Doppler shift | 0.000 045 | ppm/s | 0.27 | ppm/s (*) |

| variation (earth fixed | | | |
|---|---|---|---|
| user equipment) | | | |
| User equipment motion | 1000 | km/h (e.g. aircraft) | 500 km/h (e.g. high |

| on the earth | | speed train) |
|---|---|---|
| | | Possibly 1000 km/h |
| | | (e.g. aircraft) |
| User equipment | Omnidirectional antenna (linear polarisation), | |
| antenna types | assuming 0 dBi | |
| | Directive antenna (up to 60 cm equivalent aperture | |
| | diameter in circular polarisation) | |
| User equipment Tx | Omnidirectional antenna: UE power class 3 with | |
| power | up to 200 mW | |
| | Directive antenna: up to 4 W | |
| User equipment Noise | Omnidirectional antenna: 7 dB | |
| figure | Directive antenna: 1.2 dB | |
| Service link | 3GPP defined New Radio | |
| Feeder link | 3GPP or non-3GPP defined | 3GPP or non-3GPP |
| | Radio interface | defined Radio interface |

NOTE 1:
Each satellite has the capability to steer beams towards fixed points on earth using beamforming techniques. This is applicable for a period of time corresponding to the visibility time of the satellite
NOTE 2:
Max delay variation within a beam (earth fixed user equipment) is calculated based on Min Elevation angle for both gateway and user equipment
NOTE 3:
Max differential delay within a beam is calculated based on Max beam foot print diameter at nadir

See, TR 38.821, Solutions for NR to support non-terrestrial networks, 3GPP, 16.1.0, June 2021; RP-193234, Solutions for NR to support non-terrestrial networks (NTN), 3GPP RAN #86.

For scenario D, which is LEO with regenerative payload, both earth-fixed and earth moving beams have been listed. So, when we factor in the fixed/non-fixed beams, we have an additional scenario. The complete list of 5 scenarios in 3GPP TR 38.821 is then:
Scenario A—GEO, transparent satellite, Earth-fixed beams;
Scenario B—GEO, regenerative satellite, Earth fixed beams;
Scenario C—LEO, transparent satellite, Earth-moving beams;
Scenario D1—LEO, regenerative satellite, Earth-fixed beams;
Scenario D2—LEO, regenerative satellite, Earth-moving beams.

FIG. 3 illustrates a NB-IoT System Information Block (SIB) transmission and related parameter ranges for repetition pattern within an System Information (SI) window, the duration of SI window, and the periodicity of SI window. The same repetition pattern is used for all SI messages. Thus, the illustrated SIB may be referred to as a SIB Type-x (SIBxNB). The network can configure a maximum of 80 repetitions within a SI window assuming a maximum SI window length of 160 frames (i.e., 1600 ms) and a repetition pattern where SIB is repeated in every other frame.

Similarly, for LTE-M, the possible SI window periodicities are {8, 16, 32, 64, 128, 256, 512} frames and the possible SI window lengths are {1, 2, 5, 10, 15, 20, 40, 60, 80, 120, 160, 200} ms. Similar to NB-IoT, SI messages in LTE-M can be repeated within their respective SI windows to support operation in extended coverage. Possible repetition patterns are {every frame, every second frame, every fourth frame, and every eighth frame} throughout the SI window. All SI messages have the same repetition pattern.

Some key 3GPP RAN1 agreements from the Rel-17 NR NTN WI are provided below. The Rel-17 IoT NTN WI, in principle, inherits the same agreements. These are related to satellite ephemeris/common TA broadcast and acquisition to, for example, maintain UL synchronization.

### Agreement:

Common TA Epoch time is implicitly known as a reference time defined by the starting time of a DL slot and/or frame.
   [For Future Study]: Whether this starting time is given by predefined rule or it is indicated by the Network
      Note: “implicitly known” means that UTC is not provided to define the Common TA epoch time.

### Agreement:

The UE assumes that it has lost uplink synchronization if new or additional assistance information (i.e. serving satellite ephemeris data or Common TA parameters) is not available within the associated validity duration.

### Agreement

The serving satellite ephemeris and common TA related parameters are signalled in the same SIB message and have the same epoch time.

### Agreement

A single validity duration for both serving satellite ephemeris and common TA related parameters is broadcast on the SIB.

### Agreement

Confirm the working assumption made at RAN1#106-bis-e on serving satellite ephemeris bit allocations for LEO/MEO/GEO based non-terrestrial access network:
   Support serving satellite ephemeris format bit allocations for LEO/MEO/GEO based non-terrestrial access network:
      Position and velocity state vector ephemeris format is 17 bytes payload.
         The field size for position (m) is 78 bits
         Position range is driven by GEO: +/−42 200 km
         The quantization step is 1.3m for position
         The field size for velocity (m/s) is 54 bits
         Velocity range is driven by LEO@600 km: +/−8000 m/s
         The quantization step is 0.06 m/s for Velocity
      Orbital parameter ephemeris format 18 byte payload
         Semi-major axis α (m) is 33 bits
         Range: [6500, 43000]km
         Eccentricity e is 19 bits
         Range: ≤0.015
         Argument of periapsis ω (rad) is 24 bits
         Range: [0, 2π]
         Longitude of ascending node (Ωrad) is 21 bits
         Range: [0, 2π]
         Inclination i (rad) is 20 bits
         Range: [−π/2, +π/2]
         Mean anomaly M (rad) at epoch time to is 24 bits
         Range: [0, 2π

### Agreement

When explicitly provided through SIB, Epoch time of assistance information (i.e. Serving satellite ephemeris and Common TA parameters) is the starting time of a DL sub-frame, indicated by a SFN and a sub-frame number signaled together with the assistance information.
Otherwise, when indicated in SIB (other than SIB1), epoch time of assistance information (i.e. Serving satellite ephemeris and Common TA parameters) is implicitly known as the end of the SI window during which the SI message is transmitted.
When provided through dedicated signaling, epoch time of assistance information (i.e. Serving satellite ephemeris and Common TA parameters) is the starting time of a DL sub-frame, indicated by a SFN and a sub-frame number.

### Agreement

Modify second bullet of RAN1#107-e agreement on Epoch time as follows: Otherwise, when Epoch time is not explicitly indicated in SIB epoch time of assistance information (i.e. Serving satellite ephemeris and Common TA parameters) is implicitly known as the end of the SI window during which the NTN-specific SIB is transmitted.

### Agreement

Add one additional NTN validity duration value for GEO i.e. 900 seconds. X=4 bits.

### Agreement

Modify bit allocations for orbital parameters ephemeris format as follows:
   Orbital parameters are indicated in 21 bytes payload:
      Semi-major axis α (m) is 33 bits
         Range: from 6500 km to 43000 km
         The quantization step is 4.249×10⁻³m
      Eccentricity e is 20 bits
         Range: ≤0.015
         The quantization step is 1.431×10⁻⁸
      Argument of periapsis ω (rad) is 28 bits
         Range: from 0 to 2π
         The quantization step is 2.341×10⁻⁸ rad
      Longitude of ascending node (Ω rad) is 28 bits
         Range: from 0 to 2π
         The quantization step is 2.341×10⁻⁸ rad
      Inclination i (rad) is 27 bits
         Range: from −π/2 to +π/2
         The quantization step is 2.341×10⁻⁸ rad
      Mean anomaly M (rad) at epoch time to is 28 bits
         Range: from 0 to 2π
         The quantization step is 2.341×10⁻⁸ rad

### Conclusion

Confirm that the agreed position and velocity state vector ephemeris format for LEO/MEO/GEO may also be applied for [High Altitude Platform Station]/[Advanced Technology Groups].

IoT NTN has introduced two NTN-specific SIBs.

The first SIB contains information elements required to synchronize to the cell such as ephemeris information, common TA parameters, the UL sync validity timer duration, epoch time for assistance information. Some of the agreements of the NTN SIB include:

### RAN2#116-e:

The serving cell ephemeris information (used for [Layer1] pre-compensation) is signalled in a new SIB, which is NTN specific.
Update to serving cell ephemeris information does not affect the system information value tag and does not trigger System information modification procedure. How to trigger re-read of this information is [For Future Study (FFS)]. FFS if the UE shall reacquire the new SIB when SI update is triggered.
The timing information on when a serving cell is going to stop serving the area is broadcast in the same SIB as the ephemeris information.

### RAN2#116bis-e:

TA common parameters, UL synchronisation validity duration and ephemeris epoch time are signalled in the NTN specific SIB (SIBXX).
K_offset and K_mac parameters are signalled in the NTN specific SIB (SIBXX).
UE acquires the NTN specific SIB before accessing the cell.

### RAN2#117-e:

SIBXX is an essential SIB, i.e. the UE shall consider the cell barred if it is unable to acquire the SIB when scheduled.
UE shall acquire the NTN specific SIB before accessing the cell, regardless of the state of UL sync validity timer.
FFS if we Will have a guard timer to handle the case where the UE takes ‘forever’ reacquire the SIB. At timer expiry UE triggers [Radio Link Failure (RLF)] handling. (Note that it is expected that the timer will not expire in the normal case, and the UE can just come back according to previous decision).
For simplicity, the whole SIBXX structure is included in RRCReconfiguration message for handover.
Introduce a guard timer TXXXX for SIBXX acquisition in connected mode. At TXXX expiry, UE triggers RLF (if it can be shown in Q2 that UE will lose RLM when UE tunes away, it can be discussed to skip this timer)
Introduce a presence indicator in addition to the 2 bit [Least Significant Bit (LSB) [Evolved Absolute Radio Frequency Channel Number (EARFCN)] in the NB-IoT [Master Information Block (MIB) (eMTC—all aspects FFS)
Upon timer expiry (or UE tune away), UE stops all UL transmissions, flushes all [Hybrid Automatic Repeat Request (HARQ)] buffers and maintains all UL resources.
The UL synchronisation validity timer is maintained in [Radio Resource Control (RRC)].
Modified Proposal 4: SIBXX acquisition is captured in 5.2.2. UE actions upon ul-SyncValidityTimer expiry are described in a new section in 5.3.3, which will refer to 5.2.2 for SIBXX (re) acquisition
SIBXX is included outside mobilityControlInfo, similarly to other dedicated SIB.

In the latest CR [8], the following has been specified:

### SystemInformationBlockType31

The IE SystemInformationBlockType31 contains satellite assistance information for the serving cell.

### SystemInformationBlockType31 Information Element

-- ASN1START
SystemInformationBlockType31-r17 ::= SEQUENCE {

| servingSatelliteInfo-r17 | ServingSatelliteInfo-r17, | |
|---|---|---|
| lateNonCriticalExtension | OCTET STRING | OPTIONAL, |

...
}

| | |
|---|---|
| ServingSatelliteInfo-r17 ::= | SEQUENCE { |
| ephemerisInfo-r17 | CHOICE { |
| stateVectors | EphemerisStateVectors-r17, |
| orbitalParameters | EphemerisOrbitalParameters-r17 |

},

| nta-CommonParameters-17 | SEQUENCE { | |
|---|---|---|
| nta-Common-r17 | INTEGER (0..8316827) | OPTIONAL, -- |

Need OP

| | | |
|---|---|---|
| nta-CommonDrift-r17 | INTEGER (−261935..261935) | OPTIONAL, -- |

Need OP

| | | |
|---|---|---|
| nta-CommonDriftVariation-r17 | INTEGER (0..29470) | OPTIONAL -- |

Need OP
},

| | |
|---|---|
| ul-SyncValidityDuration-r17 | ENUMERATED {s5, s10, s15, s20, s25, |

s30, s35, s40,

s45, s50, s55, s60, s120, s180,

s240},

| epochTime-r17 | SEQUENCE { | |
|---|---|---|
| startSFN-r17 | INTEGER (0..1023), | |
| startSubFrame-r17 | INTEGER (0..9) | |
| } | | OPTIONAL, -- Need OP |
| k-Offset-r17 | INTEGER (0..1023), | |
| k-Mac-r17 | INTEGER (1..512) | OPTIONAL, -- Need |

OP
...
}
-- ASN1STOP

The second SIB has been introduced to broadcast information that is needed to handle discontinuous coverage scenario in IoT NTN. For example, it includes information elements containing satellite ephemeris of neighbouring and upcoming satellites so that the UE knows when to wake up to receive coverage. This is useful in scenarios such as, for example, low-density or sparse LEO constellations where the number of satellites in the constellation are not enough to cover the whole earth at a given time.

Some Agreements Related to this Include:
RAN2 will use a new SIB to share the ephemeris information for Discontinuous Coverage with the UEs. Sharing the information using dedicated RRC signalling is FFS.
For Discontinuous Coverage, ephemeris information of up to a maximum X satellites can be shared using the new SIB, where X is limited by the volume of information vs capacity of the SIB (X=4 is baseline). Increasing this maximum number by using dedicated RRC Signalling and by any further ephemeris optimization is FFS.

There currently exist certain challenge, however. For example, one unsolved issue for IoT NTN is how to handle NTN SIB accumulation across SI windows. Both LTE-M and NB-IoT allow SIB repetitions within a SI window. Additionally, the UEs can also possibly accumulate SIBs across multiple SI windows if needed (except for the SIBs that change frequently such as SIB16 as specified in the 3GPP specifications).

If the content of NTN SIB remains unchanged across multiple SI windows, it is beneficial to allow SIB accumulation over those windows to overcome poor coverage. However, if one or more of the NTN SIBs in the accumulated SI windows are different, it may lead to a decoding error and accumulation should be avoided.

The content of the NTN SIB(s) is partly dynamic (e.g., the ephemeris data and the Common TA parameters), which is thus problematic when SIB accumulation is needed such as, for example, for sufficiently good reception at the cell edge.

Therefore, solutions are needed to facilitate accumulation of NTN SIB.

### SUMMARY

Certain aspects of the disclosure and their embodiments may provide solutions to these or other challenges. For example, methods and systems are provided for facilitating NTN SI message prohibition or accumulation in NTN to allow operation in coverage limited conditions and to avoid decoding errors when NTN SIB contents change frequently.

According to certain embodiments, a method by a UE, for determining whether SI message accumulation is prohibited or allowed includes obtaining information about SI message accumulation. Based on the information, the UE determines whether SI message accumulation is prohibited or allowed in a NTN cell.

According to certain embodiments, a UE for determining whether SI message accumulation is prohibited or allowed is adapted to determine whether SI message accumulation is prohibited or allowed includes obtaining information about SI message accumulation. Based on the information, the UE determines whether SI message accumulation is prohibited or allowed in a NTN cell.

According to certain embodiments, a method by a network node for determining whether SI message accumulation is prohibited or allowed includes transmitting information about SI message accumulation to a UE for determination by the UE of whether SI message accumulation is prohibited or allowed in a NTN cell.

According to certain embodiments, a network node for determining whether SI message accumulation is prohibited or allowed is adapted to transmit information about SI message accumulation to a UE for determination by the UE of whether SI message accumulation is prohibited or allowed in an NTN cell.

Certain embodiments may provide one or more of the following technical advantage(s). For example, certain embodiments may provide a technical advantage of facilitating accumulation of NTN-specific SI messages including SIBs across multiple SI windows for NTN UEs in poor coverage while avoiding decoding errors due to NTN-specific SI message accumulation.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example architecture of a satellite network with bent pipe transponders;

FIG. 2 illustrates a set of parameters, which may also be referred to as orbital elements;

FIG. 3 illustrates a NB-IoT SIB transmission and related parameter ranges for repetition pattern within an SI window, the duration of SI window, and the periodicity of SI window;

FIG. 4 illustrates an example communication system, according to certain embodiments;

FIG. 5 illustrates an example UE, according to certain embodiments;

FIG. 6 illustrates an example network node, according to certain embodiments;

FIG. 7 illustrates a block diagram of a host, according to certain embodiments;

FIG. 8 illustrates a virtualization environment in which functions implemented by some embodiments may be virtualized, according to certain embodiments;

FIG. 9 illustrates a host communicating via a network node with a UE over a partially wireless connection, according to certain embodiments;

FIG. 10 illustrates an example method by a UE for determining whether SI message accumulation is prohibited or allowed, according to certain embodiments; and

FIG. 11 illustrates a method by a network node for determining whether SI message accumulation is prohibited or allowed, according to certain embodiments.

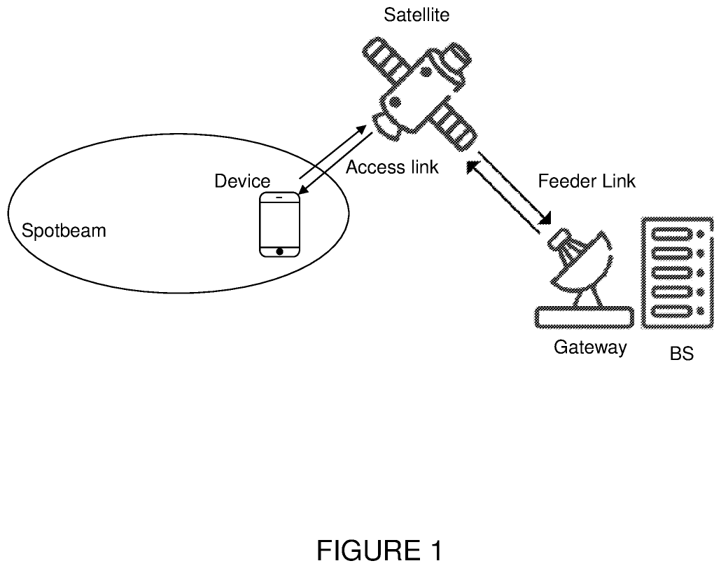

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

As used herein, SI message accumulation and SIB accumulation refers to accumulating NTN-specific SI and SIB, respectively, (which contain satellite ephemeris and/or other assistance information for NTN and may be referred to as NTN SI and NTN SIB, respectively) across one or more SI windows.

The examples and embodiments described herein for IoT NTN can also be applied to NR NTN and/or other scenarios where SI message and/or SIB accumulation is desired for a SI and/or SIB that changes frequently.

As used herein, “Updating NTN SIB” means that the contents of the NTN SIB are updated.

It may be noted that this disclosure is about NTN SI and SIB accumulation and does not alter the defined UE behavior with regards to accumulation of other legacy SI and/or SIBs. That is, the UE might as well accumulate other SI messages and/or SIBs as done in terrestrial networks.

It may be further noted that there are technically two different NTN SIBs (SystemInformationBlockType31 and SystemInformationBlockType32). The techniques and embodiments disclosed herein can be relevant to both types of NTN SIBs as both may update its ephemeris in between SI windows.

### NTN SI and SIB Accumulation

As described above, an issue for IoT NTN is how to handle NTN SI message and SIB accumulation across SI windows. Both eMTC and NB-IoT allow SIB repetitions within an SI window. The SI window configuration details for eMTC and NB-IoT are provided in Table 2. Additionally, the UEs can possibly accumulate SI messages and/or SIBs across multiple SI windows if needed for decoding (except for the SIBs that change frequently such as SIB16).

TABLE 2
SI window configuration parameters for eMTC and NB-IoT.

| | | Repetition | |
|---|---|---|---|
| | | pattern within SI | |
| | SI window length | window | SI periodicity |
| eMTC | {1, 2, 5, 10, 15, | Every radio | {8, 16, 32, 64, |
| | 20, 40, 60, 80, | frame or every | 128, 256, 512} |
| | 120, 160, 200} | {2nd, 4th, 8th} | radio frames |
| | ms | radio frame | |
| NB-IoT | {160, 320, 480, | Every {2nd, 4th, | {64, 128, 256, |
| | 640, 960, 1280, | 8th, 16th} radio | 512, 1024, 2040, |
| | 1600} ms | frame | 4096} radio frames |

If the content of NTN SIB remains unchanged across multiple SI windows, it is beneficial to allow SIB accumulation over those windows to overcome poor coverage. If the NTN SIBs in the accumulated SI windows are different, accumulation will be a futile effort as it will lead to a decoding error. Depending on the NTN scenario, it is up to the network how frequently it updates the NTN SIB. It has been observed that NTN SIB may need to be updated much more frequently for LEO than for GEO. One option is to prohibit NTN SIB accumulation across SI windows for LEO. For GEO, NTN SIB accumulation may still be beneficial since the NTN SIB is not updated frequently.

It has been observed that NTN SIB accumulation across SI windows may be more beneficial for GEO than for LEO scenarios. Depending on the SI window configuration and the NTN SIB update frequency, the UEs in poor coverage may still benefit from accumulating NTN SIBs across SI windows. Therefore, according to certain embodiments, instead of disallowing NTN SIB accumulation altogether, the network indicates it to the UE if NTN SIB accumulation is prohibited.

The NTN SIB update frequency and the SI window configuration jointly determine if NTN SIB accumulation will be beneficial.

According to certain embodiments, the network has the ability to optionally indicate if NTN SIB accumulation across SI windows is allowed or not.

The network is expected to update the NTN SIB carrying satellite ephemeris in a predictable fashion. If the NTN SIB accumulation across SI windows is allowed, it may be beneficial to broadcast the NTN SIB update periodicity to help the UE determine the number of identical NTN SIBs that it may accumulate. This would avoid the event where the UE erroneously accumulates across SI windows where different NTN SIBs were transmitted. Moreover, the network can also indicate a reference time (e.g., subframe, SFN, H-SFN) in SI to indicate the end of the SI accumulation window. This would eliminate any ambiguity about which NTN SIBs to accumulate across once the UE attempts to acquire SI.

According to certain embodiments, the SI window length may be increased for IoT NTN. This allows the network to configure a larger number of repetitions if needed. For example, in certain LEO scenarios where NTN SIB accumulation is not possible because the NTN SIB is updated every SI window, the network may configure a larger number of repetitions. As evident from Table 1, additional values for the SI window lengths can be added for IoT NTN using the existing number of bits for both eMTC and NB-IoT. Table 2 presents one example solution for NTN SIB accumulation.

TABLE 2
NTN SIB accumulation for IoT NTN.

| | | | Spec. |
|---|---|---|---|
| | Pros | Cons | impact |
| Option 1: | Only meaningful in NTN scenarios where | Too restrictive for many NTN | Minimal |
| Prohibit NTN | NTN SIB will be updated during each SI | scenarios where SI window | |
| SIB | window. | periodicity is shorter than NTN | |
| accumulation | | SIB update frequency, e.g., the | |
| across SI | | maximum SI periodicity is 5.12 | |
| windows | | s for eMTC and 40.96 s for NB- | |
| | | IoT which is much shorter than | |
| | | the NTN SIB update frequency | |
| | | in GEO. | |
| | | Large SI transmission overhead | |
| | | as network may need to | |
| | | configure a larger SI window to | |
| | | support a greater number of | |
| | | repetitions in the cell to | |
| | | compensate for the lack of SIB | |
| | | accumulation. | |
| | | Coverage-limited UEs cannot | |
| | | access the network if NTN SIB | |
| | | cannot be decoded. | |
| | | Not synergistic with legacy | |
| | | eMTC/NB-IoT specification | |
| | | which supports SIB | |
| | | accumulation. | |
| Option 2: | Network has the flexibility to dynamically | 1-bit indication needed in SI. | Low |
| Network | allow/disallow NTN SIB accumulation | | |
| dynamically | depending on the NTN scenario and the SI | | |
| indicates if NTN | configuration: | | |
| SIB | If allowed, UEs in deep coverage | | |
| accumulation is | can leverage SIB accumulation to | | |
| allowed in a cell | decode the NTN SIB. | | |
| | When SIB accumulation is not | | |
| | feasible, the network may prohibit | | |
| | SIB accumulation and configure a | | |
| | larger number of repetitions | | |
| | instead. | | |
| | Lean SI transmission possible since network | | |
| | need not waste additional resources (i.e., | | |
| | longer SI windows with more repetitions) to | | |
| | cater to UEs in deep coverage since such | | |
| | UEs can accumulate NTN SIBs. | | |
| Option 2a: | Same as Option 2. | Same as Option 2. | Low |
| Network | UEs will know exactly how many SI | Reference time and/or number of | |
| dynamically | windows it can accumulate across, e.g., | identical NTN SIBs needs to be | |
| indicates if NTN | similar to epoch time, a reference time can | indicated in SI. | |
| SIB | be signalled to mark the end of the SI | | |
| accumulation is | accumulation period. | | |
| allowed in a cell | | | |
| AND indicates a | | | |
| reference time | | | |
| for SIB | | | |
| accumulation | | | |
| window | | | |
| Option 3: | Enables the network to configure a larger | UEs in poor coverage may still | Low |
| Increase SI | number of SIB repetitions to provide robust | require NTN SIB accumulation | |
| window size for | coverage. | across multiple SI windows. | |
| IoT NTN | Especially useful in scenarios where NTN | | |
| | SIB accumulation is impossible e.g., certain | | |
| | LEO scenarios where network updates the | | |
| | NTN SIB in every SI window. | | |
| | Can be used in conjunction with Option 2/2a | | |
| | to provide a greater flexibility. | | |

According to certain embodiments described herein, methods and systems are provided for facilitating NTN SI message prohibition or accumulation in NTN to allow operation in coverage limited conditions and to avoid decoding errors when NTN SI message (e.g., SIB) contents change frequently.

For example, according to certain embodiments, systems, methods, and signalling are provided to determine if NTN-specific SI message accumulation across SI windows should be allowed in an IoT NTN cell.

As another example, according to certain embodiments, systems, methods, and signalling are provided to support NTN-specific SI message accumulation across SI windows for UEs in an IoT NTN cell.

As still another example, according to certain embodiments, systems, methods, and signalling are provided for determining epoch time when NTN-specific SI message accumulation across SI windows is supported.

Prohibiting SI Message and/or SIB Accumulation Based on NTN Scenario

According to certain embodiments, SI message and/or SIB accumulation for the NTN is allowed or prohibited depending on how frequently the NTN SI message and/or SIB is updated.

As a first example, according to certain embodiments, NTN SI messages and/or SIB may need to be updated very frequently for LEO as compared to GEO. Therefore, one may need to prohibit SI message and/or SIB accumulation to avoid decoding error if a UE in LEO NTN accumulates SI messages and/or SIB across multiple SI windows where the SI and/or SIB content is different. However, no such prohibition is needed for GEO and the default UE behavior is to accumulate SI messages and/or SIB if needed.

In a particular embodiment, it is specified in a standard specification that NTN SI message and/or SIB accumulation for IoT NTN is prohibited for LEO and/or MEO and/or GEO.

In another particular embodiment, the prohibition of the NTN SI message and/or SIB accumulation is indirectly described in terms of the validity timer for UL synchronization configured by the network. This can be fixed in the specification or the network can indicate it to the UE whether or not it needs to determine NTN SI message and/or SIB prohibition based on the NTN validity timer configuration.

For example, for certain specified validity timer values or if the validity timer value exceeds a certain threshold, then there is no prohibition on SI message and/or SIB accumulation. Otherwise, SI message and/or SIB accumulation is either prohibited or only allowed within a duration less than the validity timer value.

In a further particular embodiment, this prohibition is only applicable if the UE has already acquired a validity timer configuration value i.e., no prohibition on SI message and/or SIB accumulation when the UE is acquiring the NTN SI and/or SIB for the first time and/or has not acquired a validity timer value.

In still another further particular embodiment, SI message and/or SIB accumulation is prohibited if the UE has not acquired a validity timer configuration value or if it is acquiring NTN SI and/or SIB for the first time.

In yet another particular embodiment, the network configures if NTN SI message and/or SIB accumulation is prohibited in an NTN cell and broadcasts it using SI.

As a second example, according to certain embodiments, depending on how frequently the NTN SI and/or SIB is updated and/or the SI window configuration (e.g., SI window length, SI periodicity, SI repetition pattern), it may be desirable to allow NTN SI message and/or SIB accumulation in certain cells.

In another embodiment, certain rules are defined in the specification which along with broadcast information and/or UE measurement(s), allow the UE to determine if NTN SI message and/or SIB accumulation is prohibited.

In a particular embodiment, for example, SI message and/or SIB accumulation is prohibited for UEs based on UE category and/or coverage enhancement class and/or NTN scenario type (LEO/MEO/GEO).

As yet another example, according to certain embodiments, SI message and/or SIB accumulation is prohibited for NTN UEs in good coverage (i.e., when Reference Signal Received Power (RSRP) threshold exceeds a predefined level) when the configured repetitions within the SI window exceed a predefined threshold. Otherwise, it is not prohibited.

As still another example, according to certain embodiments, SI message and/or SIB accumulation is prohibited if the SI periodicity exceeds the NTN SIB broadcast periodicity, and/or the number of repetitions configured for the SIBs exceed a certain value. The UE may determine these periodicities and repetition pattern from system information, and then determine if it is allowed to accumulate the NTN SI messages and/or SIB or not.

In another embodiment, the prohibited SI message and/or SIB accumulation forces the epoch time to not be optional (i.e., it will be mandatorily present in its SIB if SI message and/or SIB accumulation is allowed for this SIB). This is because if epoch time is not signalled, then the epoch time is based on the starting time of the DL subframe corresponding to the end of the SI window. So, if SI message and/or SIB accumulation were to happen, there would be confusions regarding where the epoch time should start or not.

In yet another embodiment, the above described ambiguity of the epoch time (when the epoch time is not explicitly indicated but defined by a default rule) caused by repetitions of the concerned SIB (e.g. systemInformationBlockType31) with identical content is alleviated by specifying a rule for when the epoch time is defined in conjunction with SIB repetitions. To this end, it is configured in the SI, e.g. in SIB1, the SIB is transmitted in sets of N identical SIBs (i.e. allowing accumulation), or N SI-windows with identical SIB transmissions (as described below) and the default epoch time is further configured or specified in relation to a specific one of these SIB transmissions or SI-windows.

For instance, that the default epoch time can be the start time of the DL subframe corresponding to the end of the first SI-window with identical SIB transmissions.

As another example, that the default epoch time can be the start time of the DL subframe corresponding to the end of the last SI-window with identical SIB transmissions.

As yet another example, the default epoch time may be the start of the DL subframe corresponding to the start of a certain SI-window in a set of SI-windows with identical SIB transmissions.

In other examples, the default epoch time is defined as the start of the transmission- or the end of the transmission-of a certain one of the consecutive transmissions of SI messages containing the concerned SIB with unchanged content.

Supporting SI message and/or SIB Accumulation in NTN Scenario

The following methods pertain to the case where NTN SI message and/or SIB accumulation is supported in an NTN cell.

In a particular embodiment, once the UE has determined that NTN SI message and/or SIB accumulation is not prohibited, it is left up to the UE implementation to determine the number of SI windows across which NTN SI messages and/or SIBs can be accumulated. For example, the UE may opportunistically attempt to decode the NTN SI and/or SIB by accumulating across SI windows on a trial-and-error basis. It may also use orbit prediction algorithms or other side information such as UL synchronization validity timer values or previously acquired satellite ephemeris/common TA parameters to estimate how frequently the satellite ephemeris/common TA etc. will be updated by the network. Then, it can attempt to accumulate the NTN SI messages and/or SIB in SI windows which fall within its estimated duration during which the NTN SIB content is expected to remain unchanged.

In a particular embodiment, once the UE has determined that NTN SI message and/or SIB accumulation is not prohibited, it is the number of SI windows across which NTN Sis and/or SIBs can be accumulated is specified in the standard specification.

In another particular embodiment, the network indicates it to the UE the number of SI windows it can accumulate across.

In a particular embodiment, a set of NTN specific SI window lengths is specified. It includes the existing SI window lengths, e.g.,. {160, 320, 480, 960, 1280, 1600} ms for NB-IoT, and adds to that additional lengths such as 3200 and 6400 ms. Similarly, as another example, the existing SI window length for LTE-M {1, 2, 5, 10, 15, 20, 40, 60, 80, 120, 160, 200} ms can also be expanded to include additional lengths such as 240, 280, 320 and 360 ms. With a longer SI window, the network may configure a larger number of repetitions of the NTN SI and/or SIB within an SI window. It may eliminate the need to accumulate NTN SI messages and/or SIB across multiple SI windows, or reduce the number of SI windows that the UE needs to accumulate across in order to correctly decode the NTN SI and/or SIB.

In a particular embodiment, the new SI window lengths are applicable to all SI windows in NTN. Alternatively, it only applies to the SI window containing the NTN SIBs and information about which SI window contains the SI message with NTN SIB can be either specified or indicated to the UE in SI.

In a particular embodiment, the existing values in the set for configuring a SI window length are fully or partially re-interpreted as different values for IoT NTN scenarios.

In a particular embodiment, the values in the set for configuring a SI window length can be different depending on the satellite orbit altitude (e.g., the set of values is different for LEO and GEO satellite orbits).

In a particular embodiment, the existing values in the set for configuring the “si-Periodicity” are either fully re-used or new values are added (e.g., longer values are appended) to it for IoT NTN scenarios.

In a particular embodiment, the existing values in the set for configuring the “si-Periodicity” are fully or partially re-interpreted as different values for IoT NTN scenarios.

In a particular embodiment, the values in the set for configuring the “si-Periodicity” can be different depending on the satellite orbit altitude (e.g., the set of values is different for LEO and GEO satellite orbits).

In a particular embodiment, the existing values in the set for configuring the “si-RadioFrameOffset” are either fully re-used or new values are added (e.g., longer values are appended) to it for IoT NTN scenarios.

In a particular embodiment, the existing values in the set for configuring the “si-RadioFrameOffset” are fully or partially re-interpreted as different values for IoT NTN scenarios.

In a particular embodiment, the values in the set for configuring the “si-RadioFrameOffset” can be different depending on the satellite orbit altitude (e.g., the set of values is different for LEO and GEO satellite orbits).

In a particular embodiment, the existing values in the set for configuring the “si-RepetitionPattern” are either fully re-used or new values are added (e.g., longer values are appended) to it for IoT NTN scenarios.

In a particular embodiment, the existing values in the set for configuring the “si-RepetitionPattern” are fully or partially re-interpreted as different values for IoT NTN scenarios.

In a particular embodiment, the values in the set for configuring the “si-RepetitionPattern” can be different depending on the satellite orbit altitude (e.g., the set of values is different for LEO and GEO satellite orbits).

Similarly, in some embodiments, if SI message and/or SIB accumulation is supported in NTN scenario, the epoch time becomes mandatorily present.

Details for Network Indication of NTN SIB Accumulation and/or Assistance Information

According to certain embodiments, the network uses one or more of the following methods to indicate one or more of the aforementioned information to the UEs in an NTN cell.

In particular embodiments, the network may indicate 1-bit information about SI message and/or SIB accumulation prohibition using
MIB
SIB other than the NTN SIB, e.g. in SIB1, e.g. in the SI scheduling information
Different SI-RNTI is defined and specified to indicate NTN SIB accumulation is allowed in addition to the existing SI-RNTI. This enables selectively allowing accumulation per SI message (and thus SIB selective) and may also be dynamically changed between SI message transmissions and SI-windows.

In another particular embodiment, the SI message and/or SIB accumulation targets a specific NTN SIB, which is either the NTN SIB needed for UL synchronization (SystemInformationBlockType31) or the NTN SIB used for discontinuous coverage (SystemInformationBlockType32). This can be specified and/or additionally indicated to the UE. Alternatively, SI message and/or SIB accumulation information is applicable to both NTN SIBs.

Further Configuration Examples for SI message and/or SIB Accumulation in IoT NTN

As previously described, the number of repeated SIB transmissions (of a certain SIB, e.g. an NTN SIB such as systemInformationBlockType31 or systemInformationBlockType32) can be configured and signaled in another SIB, preferably a SIB in which the content is static, or semi-static, so that the UE can apply SIB accumulation for that SIB without restrictions.

The indication would first of all consist of an indication of the number, N, of consecutive SIB transmission without update of the content (i.e., the number of identical repeated SIB transmissions). The transmissions of the concerned SIB will, thus, be transmitted in repeated sets of N identical transmissions (i.e. with unchanged content). There would hence be a set of N transmissions of the unchanged SIB, followed by another set of N identical SIB transmissions, where updates of the SIB content can only occur between two sets.

To allow a UE to a priori identify the start of a set of N identical SIB transmissions, a reference is needed. This reference could be specified and a natural definition could be that the first transmission of a set of identical SIB transmissions occurs in the first SI-window (containing an SI message with the concerned SIB) starting at or after SFN=0. The N identical transmissions would be followed by a potentially updated transmission, which marks the first transmission of another set of N identical SIB transmissions.

A disadvantage of using SFN=0 as the reference is that this would be somewhat restrictive, since it forces an update (or at least that the UE has to assume that there is an update) of the SIB every SFN cycle wrap-around (which occurs after 1024 SFNs). This would exclude repetition across SI-windows when the SI-window periodicity is 4096, 2048, or 1024 frames and would allow accumulation of only two SI-window transmissions when the SI-window periodicity is 512 frames. If Hyper-SFNs are considered for IoT-NTN, this is easily solved by making the start of H-SFN =0 the reference instead of SFN=0. Otherwise, an unambiguous reference that does not restrict the repetition and accumulation possibilities can be realized by combining SFN =0 with a UTC as the reference, e.g. the occurrence of SFN=0 that is the closest to UTC=xxxxx. This can still be specified, since the UTC “xxxxx” could also be specified, as long as “xxxxx” is a time that occurred in the past, e.g. the start of the UTC time-keeping.

The above describes the configuration parameter N as indicating the number of consecutive identical transmissions of the concerned SIB. In an alternative embodiment, the configuration parameter N instead indicates the number of SI-windows (in which the SI message containing the concerned SIB is transmitted) the concerned SIB will be unchanged. This means that repetitions within an SI-window and the number of SI-windows indicated by N are multiplied to give the number of consecutive transmissions of the concerned SIB with unchanged content. For example, if the concerned SIB is transmitted twice within each SI-window (in which the SI message containing the concerned SIB is transmitted) and the SIB remains unchanged for N=2 such SI-windows, the number of identical SIB transmissions is 2×2=4.

In a particular embodiment, N is not indicated in the SI but is specified in a standard specification. In such a case, different N values may be specified for different network deployment scenarios, e.g. for LEO, MEO, GEO and HAPS/HIBS deployments.

In another particular embodiment, N is configured in the USIM, e.g. when the USIM (e.g. on a SIM card) is provisioned or configured in the USIM using Over-The-Air (OTA) configuration.

In a particular embodiment, the reference for the start of a set of N identical SIB transmission or a set of N SI-windows (in which the SI message containing the concerned SIB is transmitted) the concerned SIB will be unchanged, is configured in the system information such as, for example, in SIB1.

In another particular embodiment, the network does not necessarily need to send a different SIB after N identical transmissions. In practice, it may send the same SIB in the next N transmissions but as far as the UE behavior is concerned, UE will assume that SIB content can be potentially different after the N transmissions and that it should refrain from accumulating SIBs other than the indicated N transmissions.

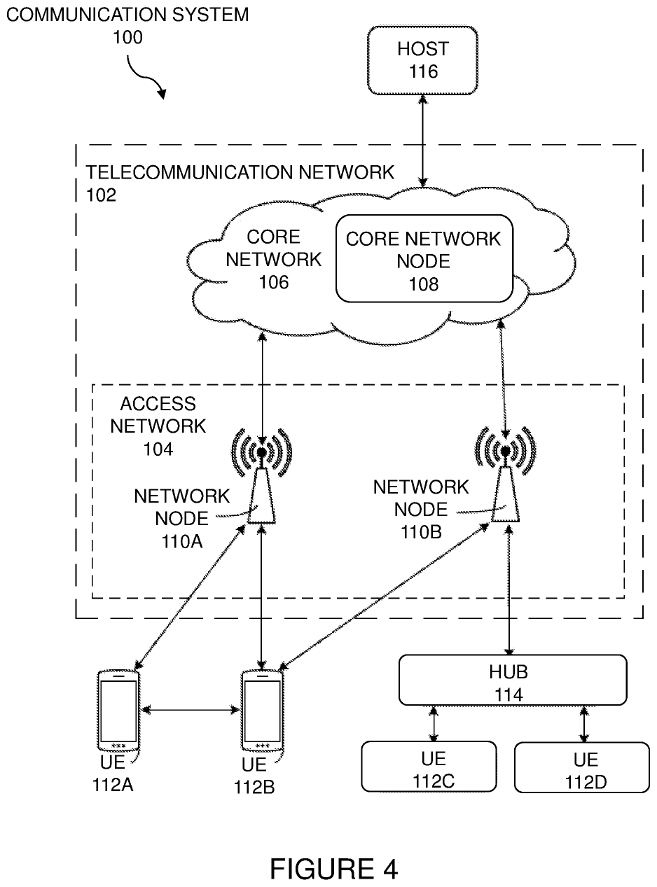

FIG. 4 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub-that is, a hub whose primary function is to route communications to/from the UEs from/to the network node 110b. In other embodiments, the hub 114 may be a non-dedicated hub-that is, a device which is capable of operating to route communications between the UEs and network node 110b, but which is additionally capable of operating as a communication start and/or end point for certain data channels.

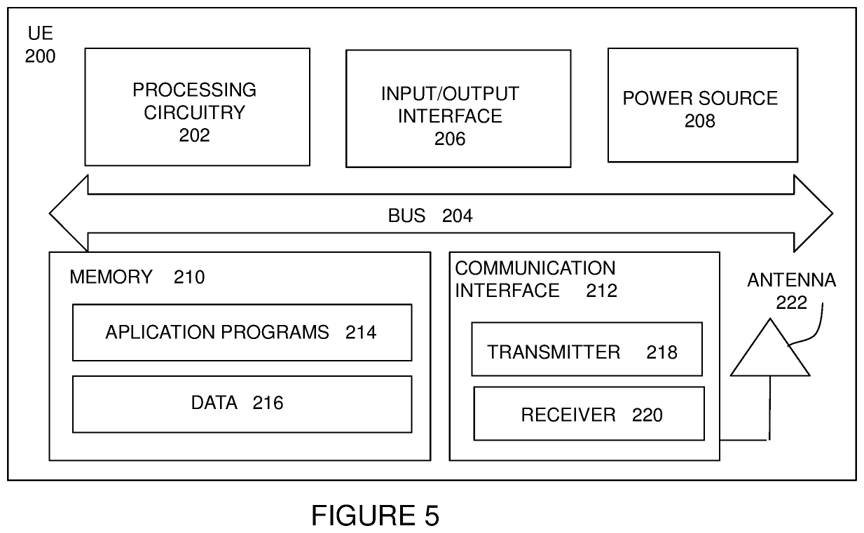

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

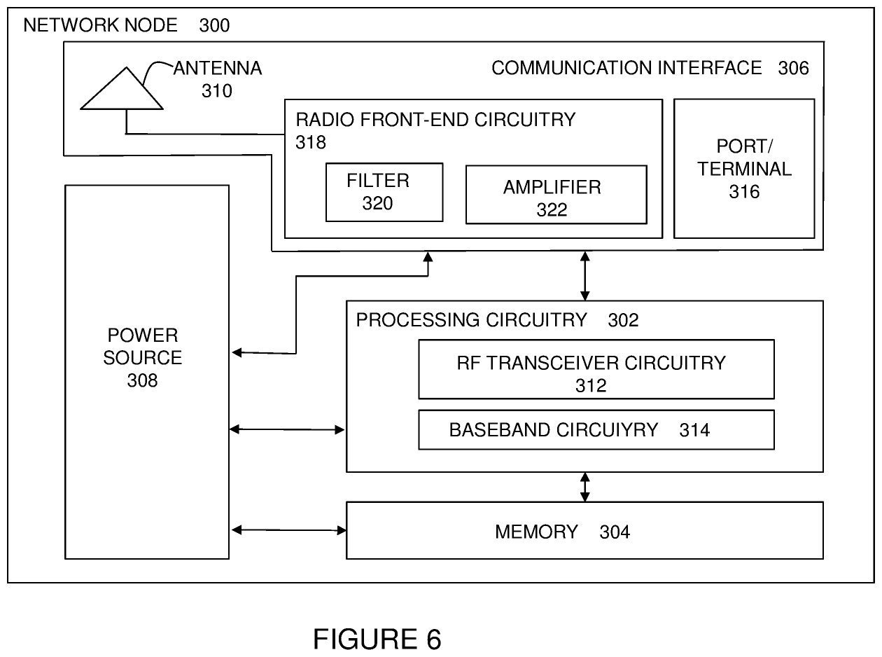

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

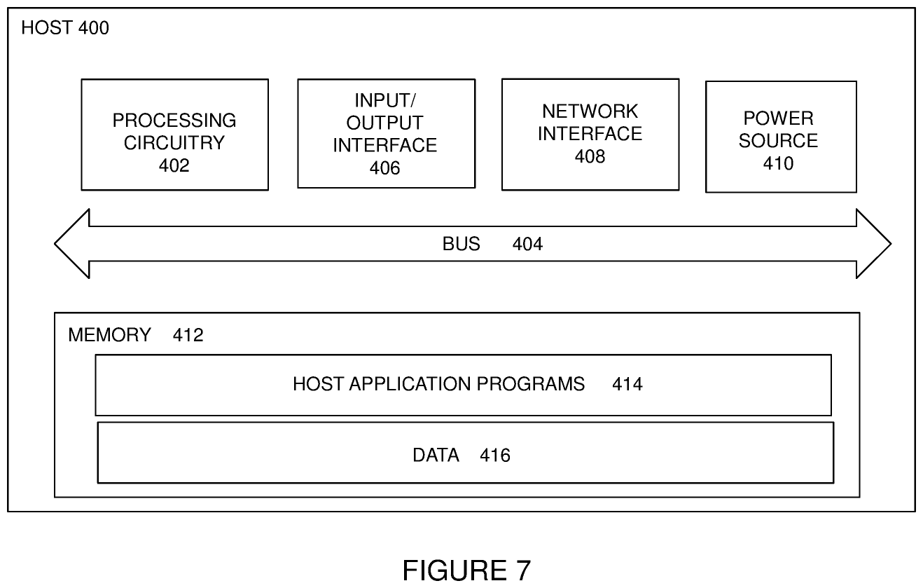

FIG. 7 is a block diagram of a host 400, which may be an embodiment of the host 116 of FIG. 4, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

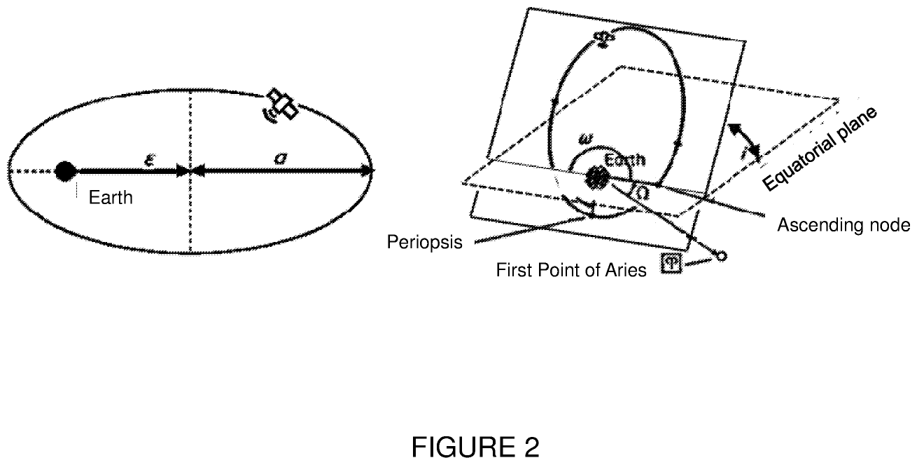

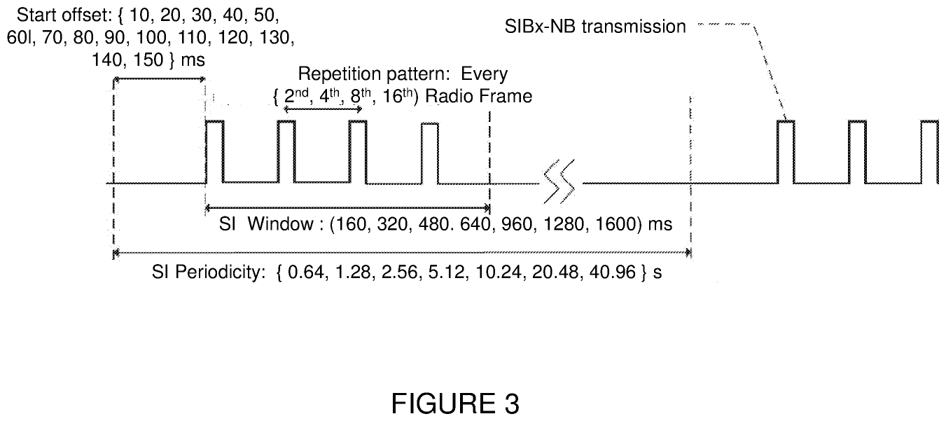

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

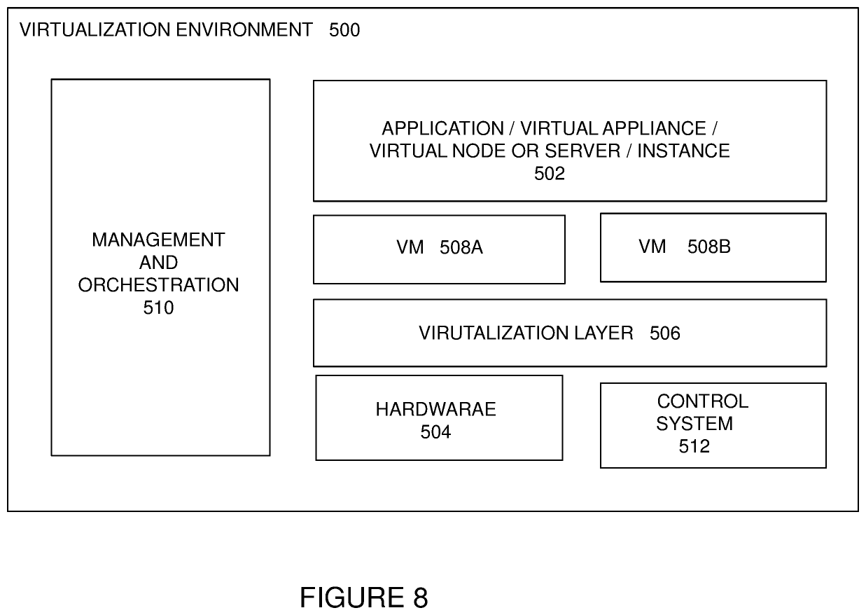

FIG. 8 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of an application 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

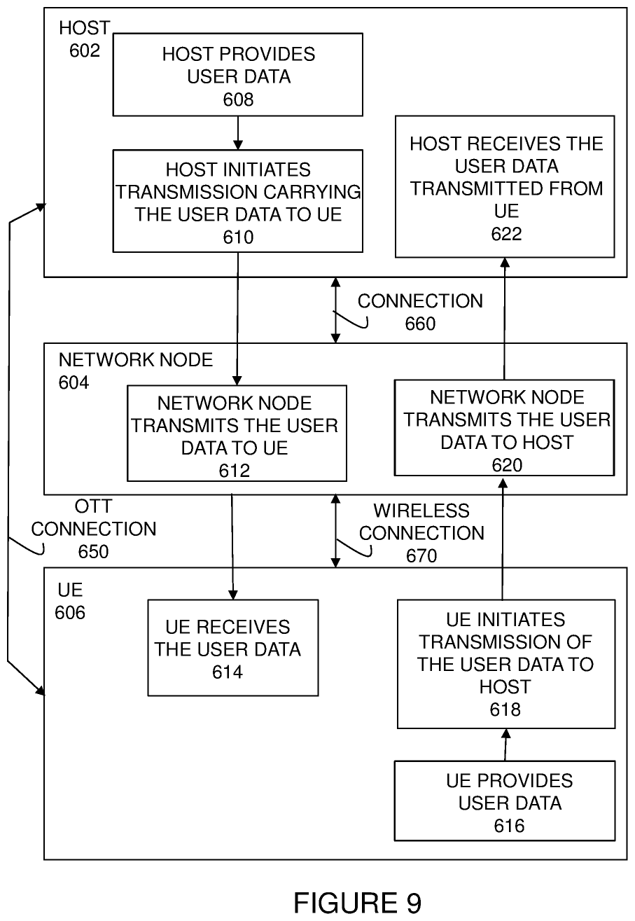

FIG. 9 shows a communication diagram of a host 602 communicating via a network node 604 with a UE 606 over a partially wireless connection in accordance with some embodiments.

Example implementations, in accordance with various embodiments, of the UE (such as a UE 112a of FIG. 4 and/or UE 200 of FIG. 5), network node (such as network node 110a of FIG. 4 and/or network node 300 of FIG. 6), and host (such as host 116 of FIG. 4 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in operation 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In operation 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in operation 612, the network node 604 transmits to the UE 606 the user data that was carried in the transmission that the host 602 initiated, in accordance with the teachings of the embodiments described throughout this disclosure. In operation 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in operation 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in operation 618, transmission of the user data towards the host 602 via the network node 604. In operation 620, in accordance with the teachings of the embodiments described throughout this disclosure, the network node 604 receives user data from the UE 606 and initiates transmission of the received user data towards the host 602. In operation 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

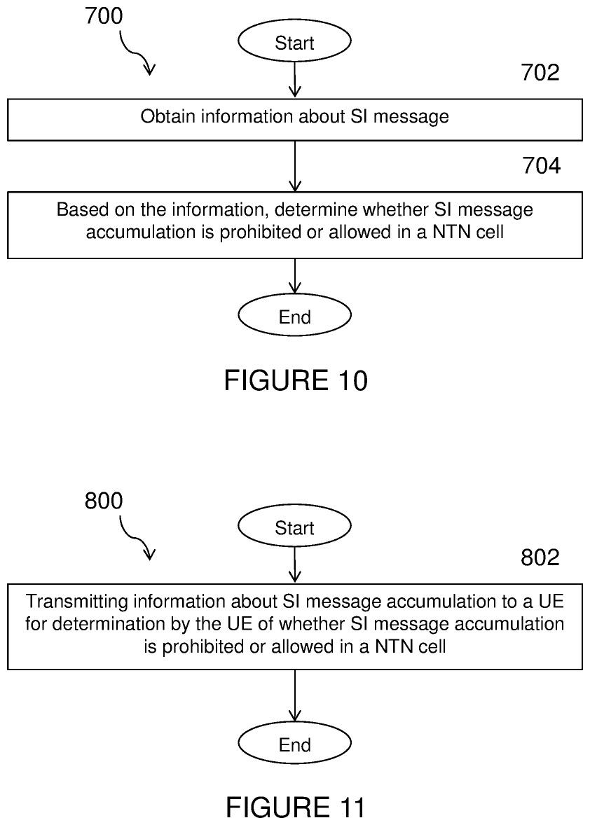

FIG. 10 illustrates an example method 700 by a UE 112 for determining whether SI message accumulation is prohibited or allowed, according to certain embodiments. The method includes obtaining information about SI message accumulation, at operation 702. Based on the information, the UE 112 determines, at operation 704, whether SI message accumulation is prohibited or allowed in a NTN cell.

In a particular embodiment, the information about SI message accumulation indicates that SI message accumulation is allowed or that SI message accumulation is prohibited.

In a particular embodiment, the information indicates that SI message accumulation is prohibited or allowed for at least one type of satellite. The UE determines a type of satellite associated with the NTN cell and whether SI message accumulation is allowed or prohibited based on the type of satellite associated with the NTN cell.

In a particular embodiment, the information indicates a maximum frequency for updating NTN SI, and the UE determines a frequency at which NTN SI is updated for the NTN cell. If the frequency at which the NTN SI is updated for the NTN cell is greater than the maximum frequency, the UE determines that SI message accumulation is prohibited. Or, if the frequency at which the NTN SI is updated for the NTN cell is less than the maximum frequency, the UE determines that SI message accumulation is allowed.

In a particular embodiment, the information is associated with a validity timer for uplink synchronization, and the UE determines whether SI message accumulation is allowed or prohibited based on the information associated with the validity timer for uplink synchronization. In a particular embodiment, at least one of the following applies: the UE determines that SI message accumulation is allowed when a value associated with the validity timer for uplink synchronization is greater than or equal to a threshold; the UE determines that SI message accumulation is prohibited when the value associated with the validity timer for uplink synchronization is less than a threshold; the UE determines that SI message accumulation is allowed when a value associated with the validity timer for uplink synchronization is equal to a specified value; the UE determines that SI message accumulation is allowed when the UE has not received a value associated with the validity timer for uplink synchronization; and the UE determines that SI message accumulation is prohibited when the UE has not received a value associated with the validity timer for uplink synchronization.

In a particular embodiment, obtaining the information includes receiving, by the UE, the information from a network node. In a further particular embodiment, the information is received in SI.

In a further particular embodiment, the information includes at least one SI-RNTI, and at least one of the following applies: the UE determines whether the SI message accumulation is allowed or prohibited for at least one SI message and/or at least one SI window based on the at least one SI-RNTI; and the at least one SI-RNTI is indicated on a per-SI message basis and the UE determines whether the SI message accumulation is allowed or prohibited for each SI message based on an associated one of the at least one SI-RNTI.

In a particular embodiment, the information is associated with a SI window configuration, and the UE determines whether the SI message accumulation is allowed or prohibited based on the information associated with the SI window configuration. The information associated with the SI window configuration includes at least one of: an SI update frequency, a SI window length, a SI periodicity, a SI repetition pattern.

In a particular embodiment, the information includes at least one rule or at least one condition for determining whether SI message accumulation is allowed or prohibited, and the at least one condition and/or the at least one rule indicates that SI message accumulation is prohibited for at least one of: a UE category, a coverage enhancement class, a type of NTN satellite. The UE determines whether SI message accumulation is allowed or prohibited based on the at least one rule or whether the at least one condition is fulfilled.

In a particular embodiment, the UE determines that SI message accumulation is prohibited when at least one of: a signal quality in the NTN cell is greater than or equal to a first threshold; a number of configured repetitions within a SI window is greater than or equal to a second threshold; a SI periodicity is greater than or equal to a NTN SIB broadcast periodicity; and a number of repetitions configured for SIBS is greater than or equal to a third threshold.

In a particular embodiment, the UE determines that SI message accumulation is allowed, and the UE determines at least one of: a number of SI windows across which NTN SI messages are to be accumulated, a number of SI windows over which NTN SI messages are expected to be unchanged, and a number of repeated SI transmissions over which NTN SI messages are to be accumulated, and accumulating NTN SI messages in the number of SI windows and/or number of repeated SI transmissions.

In a further particular embodiment, the number of SI windows and/or the number of repeated SI transmissions is determined based on at least one of: a trial-and-error basis; an orbit prediction algorithm; an uplink synchronization validity timer value; satellite ephemeris information; a TA parameter; a specification; a USIM; SIB1; and a SI window length that is determined from a set of SI window lengths.

In a particular embodiment, the UE receives, from a network node, the number of SI windows and/or the number of repeated SI transmissions.

In a particular embodiment, the UE determines a first set of SI windows and/or a first set of repeated SI transmissions that is associated with the information about SIB accumulation. The UE determines whether SI message accumulation is prohibited or allowed in the NTN cell for the first set of SI windows and/or the first set of repeated SI transmissions, and the UE receives a SI message in the first set of SI windows and/or the first set of repeated SI transmissions. The SI message that is received in the first set of SI windows and/or the first set of repeated SI transmissions is identical.

In a further particular embodiment, the UE determines that SI message accumulation is allowed for the first set of SI windows and/or the first set of repeated SI transmissions, and the UE accumulates SI messages over the first set of SI windows and/or the first set of repeated SI transmissions.

FIG. 11 illustrates a method 800 by a network node 110 for determining whether SI message accumulation is prohibited or allowed, according to certain embodiments. The method includes, at operation 802, transmitting information about SI message accumulation to a UE 112 for determination by the UE 112 of whether SI message accumulation is prohibited or allowed in a NTN cell.

In a particular embodiment, the information about SI message accumulation indicates that SI message accumulation is allowed or that SI message accumulation is prohibited.

In a particular embodiment, the information indicates that SI message accumulation is prohibited or allowed for at least one type of satellite.

In a particular embodiment, the information indicates a maximum frequency for updating NTN SI. If the frequency at which the NTN SI is updated for the NTN cell is greater than or equal to the maximum frequency, SI message accumulation is prohibited. If the frequency at which the NTN SI is updated for the NTN cell is less than the maximum frequency, SI message accumulation is allowed.

In a particular embodiment, the information is associated with a validity timer for uplink synchronization, and SI message accumulation is allowed or prohibited based on the information associated with the validity timer for uplink synchronization.

In a particular embodiment, at least one of the following applies: SI message accumulation is allowed when a value associated with the validity timer for uplink synchronization is greater than a threshold; SI message accumulation is prohibited when a value associated with the validity timer for uplink synchronization is less than a threshold; SI message accumulation is allowed when a value associated with the validity timer for uplink synchronization is equal to a specified value; SI message accumulation is allowed when the UE has not received a value associated with the validity timer for uplink synchronization; and SI message accumulation is prohibited when the UE has not received a value associated with the validity timer for uplink synchronization.

In a particular embodiment, the information is transmitted in SI.

In a particular embodiment, the information comprises at least one SI-RNTI, and wherein at least one of: the SI message accumulation is allowed or prohibited for at least one SI message and/or at least one SI window based on the at least one SI-RNTI; the at least one SI-RNTI is indicated on a per-SI message basis and the SI message accumulation is allowed or prohibited for each SI message based on an associated one of the at least one SI-RNTI; the information is associated with a SI window configuration, and wherein the SI message accumulation is allowed or prohibited based on the information associated with the SI window configuration; and the information associated with the SI window configuration comprises at least one of: an NTN SIB update frequency, a SI window length, a SI periodicity, a SI repetition pattern.

In a particular embodiment, the information comprises at least one rule or at least one condition for determining by the UE whether SI message accumulation is allowed or prohibited, and the SI message accumulation is allowed or prohibited based on the at least one rule or whether the at least one condition is fulfilled.

In a particular embodiment, the SI message accumulation is prohibited when at least one of: a signal quality in the NTN cell is greater than or equal to a first threshold; a number of configured repetitions within a SI window is greater than or equal to a second threshold; a SI periodicity is greater than or equal to a NTN SIB broadcast periodicity; and a number of repetitions configured for SIBS is greater than or equal to a third threshold.

In a particular embodiment, SI message accumulation is allowed and the information indicates at least one of: a number of SI windows across which NTN SI messages are to be accumulated, a number of SI windows over which NTN SI messages are expected to be unchanged, and a number of repeated SI transmissions over which NTN SI messages are to be accumulated.

In a particular embodiment, the network node transmits, to the UE, NTN SI in the number of SI windows and/or number of repeated SI transmissions.

In a further particular embodiment, the number of SI windows and/or the number of repeated SI transmissions is based on at least one of: a trial-and error basis; an orbit prediction algorithm; an uplink synchronization validity timer value; satellite ephemeris information; a TA parameter; a specification; a USIM; a SI window length that is determined from a set of SI window lengths; and SIB1.

In a particular embodiment, the information indicates a first set of SI windows and/or a first set of repeated SI transmissions that is associated with the information about SI message accumulation. SI message accumulation is prohibited or allowed in the NTN cell for the first set of SI windows and/or the first set of repeated SI transmissions.

In a particular embodiment, the network node transmits a SI message in each SI window of the first set of SI windows and/or in each of the first set of repeated SI transmissions, and the SI message that is transmitted in each SI window of the first set of SI windows and/or in each of the first set of repeated SI transmissions is identical.

In a particular embodiment, the network node transmits, to the UE, additional information about SI message accumulation for a second set of SI windows and/or a second set of repeated SI transmissions. SI message accumulation is allowed in the NTN cell in the second set of SI windows and/or second set of repeated SI transmissions. The network node transmits a SI message each SI window in the second set of SI windows and/or in each of the second set of repeated SI transmissions, and the SI message transmitted in each SI window of the second set of SI windows and/or in each of the second set of repeated SI transmissions is different from the SI message transmitted in the first set of SI windows and/or in each of the first set of repeated SI transmissions.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for determining whether

SIB accumulation is prohibited or allowed, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for determining whether SIB accumulation is prohibited or allowed, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for determining whether SIB accumulation is prohibited or allowed, the method comprising: obtaining information about System Information Block (SIB) accumulation; based on the information, determining whether SIB accumulation is prohibited or allowed (i.e., not prohibited) in an NTN cell.

Example Embodiment C2. The method of Example Embodiment C1, wherein the information about SIB accumulation indicates whether SIB accumulation is allowed or prohibited.

Example Embodiment C3. The method of any one or more of Example Embodiments C1 to C2, wherein the information indicates that SIB accumulation is prohibited or allowed for at least one type of satellite.

Example Embodiment C4. The method of Example Embodiment C3, further comprising determining a type of satellite associated with the NTN cell and wherein the UE determines whether SIB accumulation is allowed or prohibited based on the type of satellite associated with the NTN cell.

Example Embodiment C5. The method of any one of Example Embodiments C3 to C4, wherein the type of satellite associated with the NTN cell comprises: LEO, MEO, or GEO.

Example Embodiment C6. The method of any one or more of Example Embodiments C1 to C5, wherein the information indicates a maximum frequency for updating NTN SIB, and the method further comprises: determining a frequency at which NTN SIB is updated for the NTN cell; and if the frequency at which the NTN SIB is updated for the NTN cell is greater than the maximum frequency, determining that SIB accumulation is prohibited, or if the frequency at which the NTN SIB is updated for the NTN cell is less than the maximum frequency, determining that SIB accumulation is allowed.

Example Embodiment C7. The method of any one of Example Embodiments C1 to C6, wherein the information is associated with a validity timer for UL synchronization, and wherein the UE determines whether SIB accumulation is allowed or prohibited based on the information associated with the validity timer for UL synchronization.

Example Embodiment C8. The method of Example Embodiment C7, wherein the UE determines that SIB accumulation is allowed when a value associated with the validity timer for UL synchronization is greater than a threshold.

Example Embodiment C9. The method of Example Embodiment C7, wherein the UE determines that SIB accumulation is prohibited when a value associated with the validity timer for UL synchronization is less than a threshold. Example Embodiment C10. The method of Example Embodiment C7, wherein the

UE determines that SIB accumulation is allowed when a value associated with the validity timer for UL synchronization is equal to a specified value.

Example Embodiment C11. The method of Example Embodiment C7, wherein the UE determines that SIB accumulation is allowed when the UE has not received a value associated with the validity timer for UL synchronization.

Example Embodiment C12. The method of Example Embodiment C7, wherein the UE determines that SIB accumulation is prohibited when the UE has not received a value associated with the validity timer for UL synchronization.

Example Embodiment C13. The method of any one of Example Embodiments C1 to C12, wherein obtaining the information comprises receiving the information from a network node.

Example Embodiment C14. The method of Example Embodiment C13, wherein the information is received in System Information (SI).

Example Embodiment C15A. The method of any one of Example Embodiments C13 to C14, wherein the information is received in a Master Information Block (MIB) or a SIB other than a NTN SIB (e.g. SIB1).

Example Embodiment C15B.The method of any one of Example Embodiments C13to C14, wherein the information comprises at least one SI-RNTI, and wherein the UE determines whether the SIB accumulation is allowed or prohibited for at least one SI message and/or at least one SI window based on the at least one SI-RNTI.

Example Embodiment C15C.The method of Example Embodiment C15B, wherein the at least one SI-RNTI is indicated on a per-SI message basis, and wherein the UE determines whether the SIB accumulation is allowed or prohibited for each SI message based on an associated one of the at least one SI-RNTI.

Example Embodiment C15D. The method of Example Embodiment C15B, wherein the at least one SI-RNTI is indicated on a per-SI transmission basis, and wherein the UE determines whether the SIB accumulation is allowed or prohibited for each SI transmission based on an associated one of the at least one SI-RNTI.

Example Embodiment C15E. The method of Example Embodiment C15B, wherein the at least one SI-RNTI is indicated on a per-SI window basis, and wherein the UE determines whether the SIB accumulation is allowed or prohibited for each SI window based on an associated one of the at least one SI-RNTI.

Example Embodiment C15F. The method of any one of Example Embodiments C14to C15B, wherein the information indicates a NTN SIB that is used for UL synchronization of discontinuous coverage.

Example Embodiment C16. The method of Example Embodiment C1 to C15F, wherein the information is associated with a SI window configuration, and wherein the UE determines whether the SIB accumulation is allowed or prohibited based on the information associated with the SI window configuration.

Example Embodiment C17. The method of Embodiment C16, wherein the information associated with the SI window configuration comprises at least one of: an NTN SIB update frequency, a SI window length, a SI periodicity, a SI repetition pattern.

Example Embodiment C18. The method of any one of Example Embodiments C1 to C17, wherein the information comprises at least one rule for determining whether SIB accumulation is allowed or prohibited.

Example Embodiment C19. The method of any one of Example Embodiments C1 to C18, wherein the information comprises at least one condition, and wherein the UE determines whether SIB accumulation is allowed or prohibited based on whether the condition is fulfilled.

Example Embodiment C20. The method of any one of Example Embodiments C18 to C19, wherein the at least one condition and/or the at least one rule indicates that SIB accumulation is prohibited for at least one of: a UE category, a coverage enhancement class, a type of NTN satellite.

Example Embodiment C21. The method of any one of Example Embodiments C1 to C20, wherein the UE determines that SIB accumulation is prohibited when at least one of: a signal quality in the NTN cell is greater than a first threshold; a number of configured repetitions within a SI window is greater than a second threshold; a SI periodicity is greater than a NTN SIB broadcast periodicity; and a number of repetitions configured for SIBS is greater than a third threshold.

Example Embodiment C22. The method of any one of Example Embodiments C1 to C21, further comprising determining, based on whether SIB accumulation is allowed or prohibited, whether an epoch time is included in a SIB.

Example Embodiment C23. The method of Example Embodiment C22, wherein the epoch time is included in the SIB when SIB accumulation is allowed.

Example Embodiment C24. The method of any one of Example Embodiments C1 to C21, wherein a default epoch time is set based on a number of SIB repetitions or a number of SI windows, and wherein the default epoch time is: a start of a DL subframe corresponding to an end of a first SI window with identical SIB transmissions, a start time of a DL subframe corresponding to an end of a last SI window with identical SIB transmissions, a start of a DL subframe corresponding to a start of a certain SI window in a set of SI windows with identical SIB transmissions; a start of a certain transmission within a set of consecutive transmissions of SI messages with unchanged SIB; or an end of a certain transmission with a set of consecutive transmissions of SI messages with unchanged SIB.

Example Embodiment C25. The method of any one of Example Embodiments C1 to C24, wherein the UE determines that SIB accumulation is allowed (i.e., not prohibited) and wherein the method further comprises determining at least one of: a number (e.g., set) of SI windows across which NTN SIBs are to be accumulated, a number (e.g., set) of SI windows over which NTN SIBs are expected to be unchanged, and a number (e.g., set) of repeated SI transmissions over which NTN SIBs are to be accumulated.

Example Embodiment C26. The method of Example Embodiment C25, further comprising: accumulating NTN SIB in the number of SI windows and/or number of repeated SI transmissions.

Example Embodiment C27. The method of any one of Example Embodiments C25 to C26, wherein the number of SI windows and/or the number of repeated SI transmissions is determined on a trial-and-error basis.

Example Embodiment C28. The method of any one of Example Embodiments C25 to C26, wherein the number of SI windows and/or the number of repeated SI transmissions is determined based on at least one of: an orbit prediction algorithm, an UL synchronization validity timer value; satellite ephemeris information; and a TA parameter.

Example Embodiment C29. The method of any one of Example Embodiments C25 to C28, wherein the number of SI windows and/or the number of repeated SI transmissions is determined based on at least one of: a specification, a USIM; and SIB1.

Example Embodiment C30. The method of any one of Example Embodiments C25 to C26, further comprising receiving, from a network node, the number of SI windows and/or the number of repeated SI transmissions.

Example Embodiment C31. The method of any one of Example Embodiments C25

to C26, wherein the number of SI windows and/or the number of repeated SI transmissions is determined based on a SI window length.

Example Embodiment C32. The method of Example Embodiment C31, further comprising determining the SI window length from a set of SI window lengths.

Example Embodiment C33. The method of Example Embodiment C32, wherein values in the set of SI window lengths are determined based on a satellite orbit altitude.

Example Embodiment C34. The method of any one of Example Embodiments C25 to C33, wherein the number of SI windows and/or the number of repeated SI transmissions is associated with a particular SIB and/or a particular type of SIB, and the method further comprises applying the SIB accumulation for the particular SIB and/or the particular type of SIB.

Example Embodiment C35. The method of any one of Example Embodiments C25 to C34, further comprising receiving, from the network node a number of identical SIB transmissions corresponding to the number of SI windows and/or the number of repeated SI transmissions.

Example Embodiment C36. The method of any one of Example Embodiments C25 to C35, determining a reference point indicating a starting point of the number of SI windows and/or number of repeated SI transmissions over which SIB accumulation is allowed.

Example Embodiment C37. The method of Example Embodiment C36, wherein the reference point comprises: a first SI-window containing an SI message with the associated SIB starting at or after SFN =0, or a first SI-window containing an SI message with the associated SIB starting at or after H-SFN=0.

Example Embodiment C38. The method of any one of Example Embodiments C36 to C37, further comprising receiving the reference point from the network node.

Example Embodiment C39. The method of any one of Example Embodiments C1 to C38, further comprising determining a first set of SI windows and/or a first set of repeated SI transmissions that is associated with the information about SIB accumulation; and wherein the UE determines whether SIB accumulation is prohibited or allowed in the NTN cell for the first set of SI windows and/or the first set of repeated SI transmissions.

Example Embodiment C40. The method of Example Embodiment C39 , further comprising receiving SIB in the first set of SI windows and/or the first set of repeated SI transmissions, and wherein the SIB that is received in the first set of SI windows and/or the first set of repeated SI transmissions is identical.

Example Embodiment C41. The method of Example Embodiment C40, wherein the UE determines that SIB accumulation is allowed for the first set of SI windows and/or the first set of repeated SI transmissions, and the method further comprises accumulating SIB over the first set of SI windows and/or the first set of repeated SI transmissions.

Example Embodiment C42. The method of any one of Example Embodiments C39 to C41, further comprising: obtaining additional information about SIB accumulation for a second set of SI windows and/or a second set of repeated SI transmissions; based on the additional information, determining that SIB accumulation is allowed in the NTN cell in the second set of SI windows and/or second set of repeated SI transmissions; and receiving and accumulating SIB over the second set of SI windows and/or the second set of repeated SI transmissions.

Example Embodiment C43. The method of Example Embodiment C42, wherein: the SIB received and accumulated over the second set of SI windows and/or the second set of repeated SI transmissions is different from the SIB received and accumulated over the first set of SI windows and/or the first set of repeated SI transmissions.

Example Embodiment C44. The method of Example Embodiment C42, wherein: the SIB received and accumulated over the second set of SI windows and/or the second set of repeated SI transmissions is identical to the SIB received and accumulated over the first set of SI windows and/or the first set of repeated SI transmissions.

Example Embodiment C45. The method of Example Embodiments C1 to C44, further comprising: providing user data; and forwarding the user data to a host via the transmission to the network node.

Example Embodiment C46. A user equipment comprising processing circuitry configured to perform any of the methods of Example Embodiments C1 to C45.

Example Embodiment C47. A wireless device comprising processing circuitry configured to perform any of the methods of Example Embodiments C1 to C45.

Example Embodiment C48. A wireless device adapted to perform any of the methods of Example Embodiments C1 to C45.

Example Embodiment C49. A computer program comprising instructions which when executed on a computer perform any of the methods of Example Embodiments C1 to C45.

Example Embodiment C50. A computer program product comprising computer program, the computer program comprising instructions which when executed on a computer perform any of the methods of Example Embodiments C1 to C45.

Example Embodiment C51. A non-transitory computer readable medium storing instructions which when executed by a computer perform any of the methods of Example Embodiments C1 to C45.

### Group D Example Embodiments

Example Embodiment D1. A method by a network node for determining whether SIB accumulation is prohibited or allowed, the method comprising: transmitting information about System Information Block (SIB) accumulation to a wireless device for determination by the wireless device of whether SIB accumulation is prohibited or allowed (i.e., not prohibited) in an NTN cell.

Example Embodiment D2. The method of Example Embodiment D1, wherein the information about SIB accumulation indicates whether SIB accumulation is allowed or prohibited.

Example Embodiment D3. The method of any one or more of Example Embodiments D1 to D2, wherein the information indicates that SIB accumulation is prohibited or allowed for at least one type of satellite.

Example Embodiment D4. The method of Example Embodiment D3, wherein a type of satellite associated with the NTN cell and wherein SIB accumulation is allowed or prohibited based on the type of satellite associated with the NTN cell.

Example Embodiment D5. The method of any one of Example Embodiments D3 to D4, wherein the type of satellite associated with the NTN cell comprises: LEO, MEO, or GEO.

Example Embodiment D6. The method of any one or more of Example Embodiments D1 to D5, wherein the information indicates a maximum frequency for updating NTN SIB, and wherein: if the frequency at which the NTN SIB is updated for the NTN cell is greater than the maximum frequency, SIB accumulation is prohibited, or if the frequency at which the NTN SIB is updated for the NTN cell is less than the maximum frequency, SIB accumulation is allowed.

Example Embodiment D7. The method of any one of Example Embodiments D1 to D6, wherein the information is associated with a validity timer for UL synchronization, and wherein SIB accumulation is allowed or prohibited based on the information associated with the validity timer for UL synchronization.

Example Embodiment D8. The method of Example Embodiment D7, wherein SIB accumulation is allowed when a value associated with the validity timer for UL synchronization is greater than a threshold.

Example Embodiment D9. The method of Example Embodiment D7, wherein SIB accumulation is prohibited when a value associated with the validity timer for UL synchronization is less than a threshold.

Example Embodiment D10. The method of Example Embodiment D7, wherein SIB accumulation is allowed when a value associated with the validity timer for UL synchronization is equal to a specified value.

Example Embodiment D11. The method of Example Embodiment D7, wherein SIB accumulation is allowed when the UE has not received a value associated with the validity timer for UL synchronization.

Example Embodiment D12. The method of Example Embodiment D7, wherein SIB accumulation is prohibited when the UE has not received a value associated with the validity timer for UL synchronization.

Example Embodiment D13. The method of any one of Example Embodiments C1 to C12, wherein the information is transmitted in System Information (SI).

Example Embodiment D14. The method of Example Embodiment D13, wherein the information is transmitted in a Master Information Block (MIB) or a SIB other than a NTN SIB (e.g. SIB1).

Example Embodiment D15A. The method of any one of Example Embodiments D1 to D14, wherein the information comprises at least one SI-RNTI, and wherein the SIB accumulation is allowed or prohibited for at least one SI message and/or at least one SI window based on the at least one SI-RNTI.

Example Embodiment D15B. The method of Example Embodiment D15A, wherein the at least one SI-RNTI is indicated on a per-SI message basis, and wherein the SIB accumulation is allowed or prohibited for each SI message based on an associated one of the at least one SI-RNTI.

Example Embodiment D15C. The method of Example Embodiment D15A, wherein the at least one SI-RNTI is indicated on a per-SI transmission basis, and wherein the SIB accumulation is allowed or prohibited for each SI transmission based on an associated one of the at least one SI-RNTI.

Example Embodiment D15D. The method of Example Embodiment D15A, wherein the at least one SI-RNTI is indicated on a per-SI window basis, and wherein the SIB accumulation is allowed or prohibited for each SI window based on an associated one of the at least one SI-RNTI.

Example Embodiment D15E. The method of any one of Example Embodiments D1 to D15D, wherein the information indicates a NTN SIB that is used for UL synchronization or discontinuous coverage.

Example Embodiment D16. The method of Example Embodiment D1 to D15E, wherein the information is associated with a SI window configuration, and wherein the SIB accumulation is allowed or prohibited based on the information associated with the SI window configuration.

Example Embodiment D17. The method of Embodiment D16, wherein the information associated with the SI window configuration comprises at least one of: an NTN SIB update frequency, a SI window length, a SI periodicity, a SI repetition pattern.

Example Embodiment D18. The method of any one of Example Embodiments D1 to D17, wherein the information comprises at least one rule for determining by the wireless device whether SIB accumulation is allowed or prohibited.

Example Embodiment D19. The method of any one of Example Embodiments D1 to D18, wherein the information comprises at least one condition, and wherein the SIB accumulation is allowed or prohibited based on whether the condition is fulfilled.

Example Embodiment D20. The method of any one of Example Embodiments D18 to D19, wherein the at least one condition and/or the at least one rule indicates that SIB accumulation is prohibited for at least one of: a UE category, a coverage enhancement class, a type of NTN satellite.

Example Embodiment D21. The method of any one of Example Embodiments D1 to D20, wherein the SIB accumulation is prohibited when at least one of: a signal quality in the NTN cell is greater than a first threshold, a number of configured repetitions within a SI window is greater than a second threshold, a SI periodicity is greater than a NTN SIB broadcast periodicity; and a number of repetitions configured for SIBS is greater than a third threshold.

Example Embodiment D22. The method of any one of Example Embodiments D1 to D21, wherein an epoch time is included in a SIB based on whether SIB accumulation is allowed or prohibited.

Example Embodiment D23. The method of Example Embodiment D22, further comprising including the epoch time in the SIB when SIB accumulation is allowed.

Example Embodiment D24. The method of any one of Example Embodiments D1 to D23, wherein a default epoch time is set based on a number of SIB repetitions or a number of SI windows, and wherein the default epoch time is: a start of a DL subframe corresponding to an end of a first SI window with identical SIB transmissions, a start time of a DL subframe corresponding to an end of a last SI window with identical SIB transmissions, a start of a DL subframe corresponding to a start of a certain SI window in a set of SI windows with identical SIB transmissions, a start of a certain transmission within a set of consecutive transmissions of SI messages with unchanged SIB, or an end of a certain transmission with a set of consecutive transmissions of SI messages with unchanged SIB.

Example Embodiment D25. The method of any one of Example Embodiments D1 to D24, wherein SIB accumulation is allowed (i.e., not prohibited) and the information indicates at least one of: a number (e.g., set) of SI windows across which NTN SIBs are to be accumulated, a number (e.g., set) of SI windows over which NTN SIBs are expected to be unchanged, and a number (e.g., set) of repeated SI transmissions over which NTN SIBs are to be accumulated.

Example Embodiment D26. The method of Example Embodiment D25, further comprising: transmitting, to the wireless device, NTN SIB in the number of SI windows and/or number of repeated SI transmissions.

Example Embodiment D27. The method of any one of Example Embodiments D25 to D26, wherein the number of SI windows and/or the number of repeated SI transmissions is based on at least one of: an orbit prediction algorithm, an UL synchronization validity timer value; satellite ephemeris information; a TA parameter.

Example Embodiment D28. The method of any one of Example Embodiments D25 to D27, wherein the number of SI windows and/or the number of repeated SI transmissions is based on at least one of: a specification, a USIM, and SIB1.

Example Embodiment D29. The method of any one of Example Embodiments D25 to D28, wherein the number of SI windows and/or the number of repeated SI transmissions is determined based on a SI window length.

Example Embodiment D30. The method of Example Embodiment D29, further comprising determining the SI window length from a set of SI window lengths.

Example Embodiment D31. The method of Example Embodiment D30, wherein values in the set of SI window lengths are determined based on a satellite orbit altitude.

Example Embodiment D32. The method of any one of Example Embodiments D25 to D31, wherein the number of SI windows and/or the number of repeated SI transmissions is associated with a particular SIB and/or a particular type of SIB.

Example Embodiment D33. The method of any one of Example Embodiments D25 to D32, further comprising transmitting, to the wireless device, a number of identical SIB transmissions corresponding to the number of SI windows and/or the number of repeated SI transmissions.

Example Embodiment D34. The method of any one of Example Embodiments D25 to D33, wherein the information indicates a reference point indicating a starting point of the number of SI windows and/or number of repeated SI transmissions over which SIB accumulation is allowed.

Example Embodiment D35. The method of Example Embodiment D34, wherein the reference point comprises: a first SI-window containing an SI message with the associated SIB starting at or after SFN =0, or a first SI-window containing an SI message with the associated

SIB starting at or after H-SFN =0.

Example Embodiment D36. The method of any one of Example Embodiments D1 to D35, wherein the information indicates a first set of SI windows and/or a first set of repeated SI transmissions that is associated with the information about SIB accumulation; and wherein the SIB accumulation is prohibited or allowed in the NTN cell for the first set of SI windows and/or the first set of repeated SI transmissions.

Example Embodiment D37. The method of Example Embodiment D36, further comprising transmitting SIB in the first set of SI windows and/or the first set of repeated SI transmissions, and wherein the SIB that is transmitted in the first set of SI windows and/or the first set of repeated SI transmissions is identical.

Example Embodiment D38. The method of any one of Example Embodiments D36 to D37, further comprising: transmitting, to the wireless device, additional information about SIB accumulation for a second set of SI windows and/or a second set of repeated SI transmissions, wherein SIB accumulation is allowed in the NTN cell in the second set of SI windows and/or second set of repeated SI transmissions; and transmitting SIB in the second set of SI windows and/or the second set of repeated SI transmissions.

Example Embodiment D39. The method of Example Embodiment D38, wherein: the SIB transmitted in the second set of SI windows and/or the second set of repeated SI transmissions is different from the SIB transmitted in the first set of SI windows and/or the first set of repeated SI transmissions.

Example Embodiment D40. The method of Example Embodiment D38, wherein: the SIB transmitted in the second set of SI windows and/or the second set of repeated SI transmissions is identical to the SIB transmitted in the first set of SI windows and/or the first set of repeated SI transmissions.

Example Embodiment D41. The method of any one of Example Embodiments D1 to D40, wherein the network node comprises a gNodeB (gNB).

Example Embodiment D42. The method of any of the previous Example Embodiments, further comprising: obtaining user data; and forwarding the user data to a host or a user equipment.

Example Embodiment D43. A network node comprising processing circuitry configured to perform any of the methods of Example Embodiments D1 to D42.

Example Embodiment D44. A network node adapted to perform any of the methods of Example Embodiments D1 to D42.

Example Embodiment D45. A computer program comprising instructions which when executed on a computer perform any of the methods of Example Embodiments D1 to D42.

Example Embodiment D46. A computer program product comprising computer program, the computer program comprising instructions which when executed on a computer perform any of the methods of Example Embodiments D1 to D42.

Example Embodiment D47. A non-transitory computer readable medium storing instructions which when executed by a computer perform any of the methods of Example Embodiments D1 to D42.

### Group E Example Embodiments

Example Embodiment E1. A user equipment for determining whether SIB accumulation is prohibited or allowed, comprising: processing circuitry configured to perform any of the steps of any of the Group A and C Example Embodiments; and power supply circuitry configured to supply power to the processing circuitry.

Example Embodiment E2. A network node for determining whether SIB accumulation is prohibited or allowed, the network node comprising: processing circuitry configured to perform any of the steps of any of the Group B and D Example Embodiments; power supply circuitry configured to supply power to the processing circuitry.

Example Embodiment E3. A user equipment (UE) for determining whether SIB accumulation is prohibited or allowed, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a user equipment (UE), for determining whether System Information, (SI) message accumulation is prohibited or allowed, the method comprising:
obtaining information about SI message accumulation;
based on the information, determining whether SI message accumulation is prohibited or allowed in a Non-Terrestrial Network (NTN) cell.

2. The method of claim 1, wherein the information about SI message accumulation indicates that SI message accumulation is allowed or that SI message accumulation is prohibited.

3. The method of claim 1, wherein the information indicates that SI message accumulation is prohibited or allowed for at least one type of satellite, wherein the method comprises determining a type of satellite associated with the NTN cell, and wherein the UE determines whether SI message accumulation is allowed or prohibited based on the type of satellite associated with the NTN cell.

4. The method of claim 1, wherein the information indicates a maximum frequency for updating NTN SI, and the method further comprises:
determining a frequency at which NTN SI is updated for the NTN cell; and
if the frequency at which the NTN SI is updated for the NTN cell is greater than the maximum frequency, determining that SI message accumulation is prohibited, or if the frequency at which the NTN SI is updated for the NTN cell is less than the maximum frequency, determining that SI message accumulation is allowed.

5. The method of claims 1, wherein the information is associated with a validity timer for uplink synchronization, and wherein the UE determines whether SI message accumulation is allowed or prohibited based on the information associated with the validity timer for uplink synchronization.

6. The method of claim 5, wherein at least one of:
the UE determines that SI message accumulation is allowed when a value associated with the validity timer for uplink synchronization is greater than or equal to a threshold;
the UE determines that SI message accumulation is prohibited when the value associated with the validity timer for uplink synchronization is less than a threshold;
the UE determines that SI message accumulation is allowed when a value associated with the validity timer for uplink synchronization is equal to a specified value;
the UE determines that SI message accumulation is allowed when the UE has not received a value associated with the validity timer for uplink synchronization; and
the UE determines that SI message accumulation is prohibited when the UE has not received a value associated with the validity timer for uplink synchronization.

7. The method of claim 1, wherein obtaining the information comprises receiving the information from a network node.

8. The method of claim 7, wherein the information is received in System Information (SI).

9. The method of claim 7, wherein the information comprises at least one System Information-Radio Network Temporary Identifier (SI-RNTI) and wherein at least one of:
the UE determines whether the SI message accumulation is allowed or prohibited for at least one SI message and/or at least one SI window based on the at least one SI-RNTI; and
the at least one SI-RNTI is indicated on a per-SI message basis and the UE determines whether the SI message accumulation is allowed or prohibited for each SI message based on an associated one of the at least one SI-RNTI.

10. The method of claim 1, wherein:
the information is associated with a SI window configuration,
the UE determines whether the SI message accumulation is allowed or prohibited based on the information associated with the SI window configuration, and
the information associated with the SI window configuration comprises at least one of: an SI update frequency, a SI window length, a SI periodicity, a SI repetition pattern.

11. The method of claim 1, wherein:
the information comprises at least one rule or at least one condition for determining whether SI message accumulation is allowed or prohibited;
the at least one condition and/or the at least one rule indicates that SI message accumulation is prohibited for at least one of: a UE category, a coverage enhancement class, a type of NTN satellite; and
the UE determines whether SI message accumulation is allowed or prohibited based on the at least one rule or whether the at least one condition is fulfilled.

12. The method of claim 1, wherein the UE determines that SI message accumulation is prohibited when at least one of:
a signal quality in the NTN cell is greater than or equal to a first threshold, a number of configured repetitions within a SI window is greater than or equal to a second threshold,
a SI periodicity is greater than or equal to a NTN SIB broadcast periodicity, and a number of repetitions configured for SIBS is greater than or equal to a third threshold.

13. The method of claim 1, wherein the UE determines that SI message accumulation is allowed, and wherein the method comprises:
determining at least one of:
a number of SI windows across which NTN SI messages are to be accumulated, a number of SI windows over which NTN SI messages are expected to be unchanged, and
a number of repeated SI transmissions over which NTN SI messages are to be accumulated; and
accumulating NTN SI messages in the number of SI windows and/or number of repeated SI transmissions.

14. The method of claim 13, wherein the number of SI windows and/or the number of repeated SI transmissions is determined based on at least one of:
a trial-and-error basis;
an orbit prediction algorithm;
an uplink synchronization validity timer value;
satellite ephemeris information;
a TA parameter;
a specification;
a USIM;
SIB1; and
a SI window length that is determined from a set of SI window lengths.

15. The method of claim 13, further comprising receiving, from a network node, the number of SI windows and/or the number of repeated SI transmissions.

16. The method of claim 1, comprising:
determining a first set of SI windows and/or a first set of repeated SI transmissions that is associated with the information about SIB accumulation, wherein the UE determines whether SI message accumulation is prohibited or allowed in the NTN cell for the first set of SI windows and/or the first set of repeated SI transmissions; and
receiving a SI message in the first set of SI windows and/or the first set of repeated SI transmissions, wherein the SI message that is received in the first set of SI windows and/or the first set of repeated SI transmissions is identical.

17. (canceled)

18. A method by a network node for determining whether System Information (SI) message accumulation is prohibited or allowed, the method comprising:
transmitting information about SI message accumulation to a User Equipment (UE) for determination by the UE of whether SI message accumulation is prohibited or allowed in a Non-Terrestrial Network (NTN) cell.

19. The method of claim 18, wherein the information about SI message accumulation indicates that SI message accumulation is allowed or that SI message accumulation is prohibited.

20-33. (canceled)

34. A User Equipment (UE) for determining whether System Information (SI) message accumulation is prohibited or allowed, the UE adapted to:
obtain information about SI message accumulation;
based on the information, determine whether SI message accumulation is prohibited or allowed in a Non-Terrestrial Network (NTN) cell.

35. (canceled)

36. A network node for determining whether System Information (SI) message accumulation is prohibited or allowed, the network node adapted to:
transmit information about SI message accumulation to a User Equipment (UE) for determination by the UE of whether SI message accumulation is prohibited or allowed in a Non-Terrestrial Network (NTN) cell.

37. (canceled)
